(19) United States
(12) Patent Application Publication
(10) Pub. No.: US 2009/0246518 A1
(43) Pub. Date: Oct. 1, 2009

(54) COVER FILM

(75) Inventors: Tetsuo Fujimura, Gunma (JP); Takayuki Iwasaki, Gunma (JP); Masanori Higano, Gunma (JP); Masatoshi Kawata, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Denki Kagaku Kogyo Kabushiki Kaisha, Chuo-ku (JP)

(21) Appl. No.: 12/298,147

(22) PCT Filed: Apr. 24, 2007
(86) PCT No.: PCT/JP07/58868

§ 371 Date: Oct. 23, 2008

(30) Foreign Application Priority Data
Apr. 25, 2006 (JP) 2006-120490
Dec. 28, 2006 (JP) 2006-354441

(51) Int. Cl. B32B 27/08

(52) U.S. Cl. 428/339; 428/483; 428/517

(57) ABSTRACT

To provide a cover film with which the temperature range of a sealing iron to obtain peel strength is wide and stability of peel strength is good at the time of peeling, and which is excellent in heat sealing properties to a carrier tape.

A cover film comprising a substrate layer and a sealant layer, wherein the substrate layer is made of a biaxially oriented polyester and/or a biaxially oriented polypropylene, the sealant layer contains a hydrogenated resin (a) of a block copolymer of an aromatic vinyl compound and a conjugated diene type hydrocarbon compound, the amount of the aromatic vinyl compound in the resin (a) is at least 20 mass % and at most 45 mass %, and the flowability of the resin (a) is from 1 to 20 g/10 min at a temperature of 230° C. under a load of 2.16 kgf by a measurement method stipulated in JIS K 7210.

### TECHNICAL FIELD

The present invention relates to a cover film used for an electronic component packaging bag.

### BACKGROUND ART

Along with miniaturization of electronic equipment, miniaturization and high functionality of electronic components used are also in progress. In an electronic equipment assembling process, components are automatically mounted on a printed board. For automatic mounting, tape packaging is commonly conducted so as to sequentially supply electronic components.

In the tape packaging, using a molded tape having dents in which electronic components are contained at regular intervals, an electronic component or the like is put in the dent, a cover film as a cover is put on the molded tape, and both ends of the cover film are heat-sealed continuously in the length direction by e.g. a heated sealing bar. Heretofore, as a cover film material, a laminate comprising a biaxially oriented polyester film as a substrate and a hot melt layer as a sealant layer laminated on the substrate, etc. have been used.

A component contained in a component packaging tape, having dents and comprising a cover film and a polystyrene, a polyvinyl chloride, a polycarbonate or the like, e.g. a carrier tape, is mounted on a circuit board or the like after the cover film is removed by an automatic remover at the time of mounting components in a process for producing electronic equipment or the like.

Along with miniaturization of electronic components, electronic components contained in a carrier tape are mounted at high speed, and thus a stronger tensile stress is applied to the carrier tape. Accordingly, as the carrier tape, a polycarbonate carrier tape which is excellent in tensile strength and which will hardly be broken even when pulled at high speed with high strength has been used. However, a polycarbonate carrier tape is a material which is hardly bonded to a cover film by heat sealing as compared with a polystyrene or the like. Further, since heat sealing in a short time is required for high speed component packaging, the cover film may not sufficiently be heat sealed to the polycarbonate carrier tape in some cases.

Further, if the cover film has significant non-uniformity of the peel strength with a high strength portion and a low strength portion, the carrier tape will vibrate when the cover tape is peeled off, whereby electronic components may fly up from the carrier tape, and such may cause troubles in mounting of electronic components on a substrate in some cases. Further, if the peel strength is significantly changed by the conditions of heat sealing, the cover film may be broken when peeled off, and the components in the package may not be taken out in some cases.

Cover films comprising as a sealant layer a hydrogenated product of a block copolymer of an aromatic vinyl compound and a conjugated diene type hydrocarbon compound are disclosed in e.g. Patent Documents 1 to 7. These Patent Documents failed to disclose a particularly preferred resin structure as a resin for the sealant layer, among hydrogenated resins of a block copolymer of an aromatic vinyl compound and a conjugated diene type hydrocarbon compound constituting the sealant layer.

Patent Document 1: JP-A-2-214656

Patent Document 2: JP-A-4-139287

Patent Document 3: JP-A-7-118613

Patent Document 4: JP-A-8-324676

Patent Document 5: JP-A-2001-519728

Patent Document 6: JP-A-2002-104500

Patent Document 7: JP-A-2003-155090

### DISCLOSURE OF THE INVENTION

### Object to be Accomplished by the Invention

The present invention is to provide a cover film with which the temperature range of a sealing iron to obtain aimed peel strength is broad, and which is excellent in stability of peel strength when peeled off and excellent heat sealing properties to a carrier tape.

### Means to Accomplish the Object

Namely, the present invention provides the following.

(1) A cover film comprising a substrate layer and a sealant layer, wherein the substrate layer is made of a biaxially oriented polyester and/or a biaxially oriented polypropylene, the sealant layer contains a hydrogenated resin (a) of a block copolymer of an aromatic vinyl compound and a conjugated diene type hydrocarbon compound, the amount of the aromatic vinyl compound in the resin (a) is at least 20 mass % and at most 45 mass %, and the flowability of the resin (a) is from 1 to 20 g/10 min at a temperature of 230° C. under a load of 2.16 kg by a measurement method stipulated in JIS K 7210.

(2) A cover film comprising a substrate layer and a sealant layer, wherein the substrate layer is made of a biaxially oriented polyester and/or a biaxially oriented polypropylene, the sealant layer contains a hydrogenated resin (a) of a block copolymer of an aromatic vinyl compound and a conjugated diene type compound and a polyolefin resin (b) in a content of the resin (a) of at least 65 mass % and at most 99 mass % and a content of the polyolefin resin (b) of at least 1 mass % and at most 35 mass %, the amount of the aromatic vinyl compound in the resin (a) is at least 20 mass % and at most 45 mass %, and the flowability of the resin (a) is from 1 to 20 g/10 min at a temperature of 230° C. under a load of 2.16 kgf by a measurement method stipulated in JIS K 7210.

(3) A cover film comprising a substrate layer and a sealant layer, wherein the substrate layer is made of a biaxially oriented polyester and/or a biaxially oriented polypropylene, the sealant layer contains a hydrogenated resin (a) of a block copolymer of an aromatic vinyl compound and a conjugated diene type hydrocarbon compound and a polyolefin resin (b) in a content of the resin (a) of at least 75 mass % and at most 90 mass % and a content of the polyolefin resin (b) of at least 10 mass % and at most 25 mass %, and the amount of the aromatic vinyl compound in the resin (a) is at least 20 mass % and at most 45 mass %.

(4) The cover film according to the above (2) or (3), wherein the polyolefin rein (b) is at least one member selected from the group consisting of a polyethylene resin, an ethylene/acrylic ester copolymer resin and an ethylene/vinyl acetate copolymer resin, and the flowability of the resin (b) is from 0.1 to 10 g/10 min at a temperature of 230° C. under a load of 2.16 kg by a measurement method stipulated in JIS K 7210.

(5) The cover film according to any one of the above (2) to (4), wherein of the polyolefin resin (b), the elastic modulus at 25° C. is at least 2.0×10⁷ Pa and at most 1.0×10⁹ Pa as measured in a viscoelastic spectrum (elastic modulus in tension, frequency 1 Hz, heating rate of 5° C. per minute), and the melting point (peak temperature) is at least 60° C. and at most 115° C. as measured by a DSC method at a heating rate of 5° C. per minute.

(6) The cover film according to any one of the above (1) to (5), which contains a surfactant type antistatic agent on one side or both sides of the sealant layer, and wherein the surface resistance is at most 1×10¹²Ω as measured by a measurement method stipulated in JIS K 6911 at an ambient temperature of 23° C. at an ambient humidity of 50% RH at an applied voltage of 500 V.

(7) The cover film according to the above (6), wherein the amount of solid content of the applied sealant type antistatic agent is from 3 mg/m² to 20 mg/m²

(8) The cover film according to any one of the above (1) to (7), wherein the thickness of the sealant layer is at least 8 μm and at most 40 μm.

(9) An electronic component packaging container using the cover film as defined in any one of the above (1) to (8).

### EFFECTS OF THE INVENTION

According to the present invention, a cover film can be obtained, which is excellent in stability of peel strength when peeled off, which has excellent heat sealing properties particularly heat sealing properties to a polycarbonate carrier tape, and with which the temperature range of heat sealing to obtain aimed peel strength of the cover film is broad.

### BEST MODE FOR CARRYING OUT THE INVENTION

The biaxially oriented polyester layer used for the substrate layer is a layer using a biaxially oriented polyester. As the biaxially oriented polyester, not only a commonly used polyester such as a biaxially oriented polyethylene terephthalate or a biaxially oriented polyethylene naphthalate but also one having an antistatic agent for antistatic treatment applied or incorporated, or one to which corona treatment, treatment to make bonding easy, or the like is applied may be used.

If the biaxially oriented polyester film is too thin, “film tearing” is likely to occur when the cover film is peeled off, the film tends to have weak stiffness, and the film will be difficult to handle. On the other hand, if it is too thick, the adhesion of the cover film tends to decrease. Accordingly, a film having a thickness of usually from 9 to 50 μm, preferably from 12 to 25 μm can be suitably used.

The biaxially oriented polypropylene layer used for the substrate layer is a layer using a biaxially oriented polypropylene. As the biaxially oriented polypropylene, not only a commonly used polypropylene but also one having an antistatic agent for antistatic treatment applied or incorporated, or one to which corona treatment, treatment to make bonding easy, or the like is applied, may be used.

If the biaxially oriented polypropylene film is too thin, “film tearing” is likely to occur when the cover film is peeled off, the film tends to have weak stiffness, and the film will be difficult to handle. On the other hand, if it is too thick, the adhesion of the cover film tends to decrease. Accordingly, a film having a thickness of usually from 9 to 50 μm, preferably from 12 to 25 μm can be suitably used.

In the hydrogenated resin (a) of a block copolymer of an aromatic vinyl compound and a conjugated diene type hydrocarbon compound constituting the sealant layer, the content of the aromatic vinyl compound is at least 20 mass % and at most 45 mass %, preferably at least 25 mass % and less than 35 mass %. In addition, the flowability of the resin (a) is from 1 to 20 g/10 min, preferably from 3 to 10 g/10 min at a temperature of 230° C. under a load of 2.16 kg by a measurement method stipulated in JIS K7210.

If the content of the aromatic vinyl compound is less than 20 mass %, when a cover tape is heat sealed to a carrier tape, a portion on which no sealing iron is applied will be bonded, and accordingly non-uniformity of peel strength is likely to be significant. Further, electronic components in the package will adhere to the cover tape, and such may cause troubles in mounting. On the other hand, if the content of the aromatic vinyl compound exceeds 45 mass %, the cover tape is likely to have a portion with high peel strength and a portion with low peel strength when the cover tape is peeled off from the carrier tape, which tends to cause flying up of electronic components from the carrier tape when the electronic components are mounted on a substrate. Further, when the cover tape is heat sealed to the carrier tape, peel strength is likely to change by a change in temperature of the heat sealing iron, whereby aimed peel strength is hardly obtained in some cases.

Further, if the flowability is less than 1 g/10 min, the melt tension of the molten resin tends to be high and extension by melting is small when the resin is melt extruded, and accordingly the extruded molten resin is likely to be torn, such being poor in processability. On the other hand, if the flowability exceeds 20 g/10 min, the melt tension of the molten resin tends to be low when the resin is melt extruded, and the extruded molten resin is likely to be torn, such being poor in processability, and further, when the cover tape is heat sealed to the carrier tape, a portion on which no heat sealing iron is applied is also bonded, thus increasing non-uniformity in peel strength. Further, electronic components in the package tend to be bonded to the cover tape, and such is likely to cause troubles in mounting.

When the hydrogenated resin (a) of a block copolymer of an aromatic vinyl compound and a conjugated diene type hydrocarbon compound and a polyolefin resin (b) are used for a sealant layer, the ratios of the resin (a) and the polyolefin resin are preferably such that the resin (a) is 99 to 65 mass % and the polyolefin resin (b) is 1 to 35 mass %, more preferably the resin (a) is 95 to 70 mass % and the polyolefin resin (b) is 5 to 30 mass %.

In the hydrogenated resin (a) of a block copolymer of an aromatic vinyl compound and a conjugated diene type hydrocarbon compound constituting the sealant layer, the ratio of the aromatic vinyl compound is at least 20 mass % and at most 45 mass %, preferably at least 25 mass % and less than 35 mass %, and in addition, the flowability of the resin (a) is from 1 to 20 g/10 min, preferably from 3 to 10 g/10 min at a temperature of 230° C. under a load of 2.16 kg by a measurement method stipulated in JIS K 7210.

If the amount of the polyolefin resin is larger than 35 mass %, the cover tape is likely to have a portion with high peel strength and a portion with low peel strength when the cover tape is peeled off from the carrier tape, which tends to cause flying up of electronic components from the carrier tape when the electronic components are mounted on a substrate. Further, the peel strength is likely to change by a change in the temperature of a heat sealing iron when the cover tape is heat sealed to the carrier tape, whereby aimed peel strength is hardly obtained in some cases.

In a case where the hydrogenated resin (a) of a block copolymer of an aromatic vinyl compound and a conjugated diene type hydrocarbon compound, and the polyolefin resin (b), are used for the sealant layer, the ratios of the resin (a) and the polyolefin resin (b) are such that the resin (a) is at least 75 mass % and at most 90 mass % and the polyolefin resin (b) is at least 10 mass % and less than 25 mass %, preferably the resin (a) is at least 75 mass % and at most 85 mass % and the polyolefin resin (b) is at least 15 mass % and less than 25 mass %. If the amount of the polyolefin resin (b) is less than 10 mass %, when the cover tape is heat sealed to the carrier tape, a portion on which no heat sealing iron is applied is also likely to be bonded, thus leading to significant non-uniformity of peel strength. Further, troubles in mounting are likely to be caused by adhesion of electronic components in the package to the cover film. On the other hand, if the amount of the polyolefin resin (b) is larger than 25 mass %, the peel strength is likely to change by a change in the temperature of a heat sealing iron when the cover film is heat sealed to the carrier tape, whereby aimed peel strength is hardly obtained in some cases.

The aromatic vinyl compound constituting the resin (a) for the sealant layer may, for example, be styrene, α-methylstyrene or an alkyl-substituted styrene, and among them, styrene is preferably used.

Further, the conjugated diene type hydrocarbon compound may, for example, be butadiene, isoprene, 1,3-pentadiene, 1,3-hexadiene or 2,3-dimethyl-1,3-butadiene. Among them, butadiene or isoprene is preferably used.

The hydrogenation rate of the resin (a) is usually from 90 to 100%, preferably from 95 to 100%.

The polyolefin resin (b) constituting the sealant layer may, for example, be a polypropylene or poly-1-butene, or an ethylene copolymer resin containing at least 50 mass % of ethylene. For example, a polyethylene resin such as a high density polyethylene, a linear low density polyethylene, a low density polyethylene, an ethylene/propylene random copolymer resin, an ethylene/1-butene random copolymer resin or an ethylene/1-hexene random copolymer resin; a random copolymer resin of ethylene with an acrylic ester such as methyl acrylate, ethyl acrylate, propyl acrylate, n-butyl acrylate or methyl methacrylate; or an ethylene/vinyl acetate random copolymer resin can be suitably used.

An acrylic ester random copolymer resin and an ethylene/vinyl acetate random copolymer resin contain ethylene units in an amount of at most 99 mass % and at least 50 mass %, preferably at most 95 mass % and at least 70 mass %. If the ethylene proportion is less than 50%, when the cover tape is heat sealed to the carrier tape, a portion to which no heat sealing iron is applied is likely to be bonded, thus leading to an increase in non-uniformity of peel strength. Further, electronic components in the package tend to be adhered to the cover film, and such is likely to cause troubles in mounting. Further, the cover film is likely to have a portion with high peel strength and a portion with low peel strength when the cover film is peeled off from the carrier tape, which tends to cause flying up of electronic components from the carrier tape when the electronic components are mounted on a substrate.

Of the polyolefin resin (b), the flowability is preferably from 0.1 to 10 g/10 min, more preferably from 0.1 to 5 g/10 min at a temperature of 230° C. under a load of 2.16 kg by a measurement method stipulated in JIS K7210. If the flowability is less than 0.1 g/10 min, the resin tends to have poor extrudability, and if it exceeds 10 g/10 min, when the cover tape is heat sealed to the carrier tape, even a portion to which no heat sealing iron is applied is likely to be bonded, and such is likely to cause non-uniformity of peel strength.

Of the polyolefin resin (b) for the sealant layer, the elastic modulus at 25° C. is at least 2.0×10⁷ Pa and at most 1.0×10⁹ Pa, preferably at least 5×10⁷ Pa and at most 5×10⁸ Pa as measured in a viscoelastic spectrum (elastic modulus in tension, frequency 1 Hz, heating rate of 5° C. per minute), and the melting point (peak temperature) is at least 60° C. and at most 115° C., preferably at least 60° C. and at most 100° C. as measured by a DSC method at a heating rate of 5° C. per minute.

If the elastic modulus at 25° C. is less than 2.0×10⁷ Pa, even a portion to which no heat sealing iron is applied is likely to be bonded, thus leading to significant non-uniformity of peel strength. Further, electronic components in the package are likely to be bonded to the cover film, thus leading to troubles in mounting. On the other hand, if the elastic modulus exceeds 1.0×10⁹ Pa, the peel strength of the cover film is low and no sufficient peel strength will be obtained when the cover tape is heat sealed to the carrier tape in some cases, or the peel strength is likely to suddenly change by the change in temperature of the heat sealing iron when the cover tape is heat sealed to the carrier tape, whereby aimed peel strength is hardly obtained in some cases.

If the melting point is less than 60° C., when the cover tape after heat sealing is left to stand in an atmosphere at 60° C. which is the standard of the environment in car interior in summer, the cover film is peeled off from the carrier tape in some cases, or the peel strength remarkably increases in some cases. On the other hand, if the melting point exceeds 115° C., the cover film tends to have a portion with high peel strength and a portion with low peel strength when the cover film is peeled off from the carrier tape, and electronic components are likely to fly up from the carrier tape when the electronic components are mounted on a substrate. Further, when the cover film is heat sealed to the carrier tape, the peel strength is likely to change by the change in temperature of the heat sealing iron, whereby aimed peel strength is hardly obtained in some cases.

To the cover film, antistatic treatment may be applied as the case requires. As an antistatic agent, for example, a surfactant type antistatic agent of e.g. a nonionic, cationic, anionic or amphoteric type, a polymer type antistatic agent or a conductivity-imparting agent containing metal oxide fine particles of e.g. antimony oxide or tin oxide, is applied to one of or both sides of the substrate and to one of or both sides of the sealant layer e.g. by a roll coater using gravure rolls or by spraying.

Further, it is possible to impart conductivity to the sealant layer by incorporating a surfactant type antistatic agent, a polymer type antistatic agent, a conductivity-imparting agent containing metal oxide fine particles of e.g. antimony oxide or tin oxide, or the like to the resin constituting the sealant layer. A method for imparting conductivity to the sealant layer is particularly preferably a method of applying a surfactant type antistatic agent to the surface of the sealant layer with a view to obtaining stable peel strength when the cover film is heat sealed to the carrier tape and in view of low cost.

The surface resistance of the sealant layer is preferably at most 1×10¹²Ω, preferably at most 1×10¹¹Ω, as measured by a measurement method stipulated in JIS K6911 at an ambient temperature of 23° C. at an ambient humidity of 50% RH at an applied voltage of 500 V. If the surface resistance exceeds 1×10¹²Ω, it is difficult to remove electric charge when the cover film is charged, whereby when the cover film is peeled off from the carrier tape, electronic components in the package are likely to adhere to the cover film, thus leading to troubles in mounting.

It is preferred to apply corona discharge treatment or ozone treatment to both sides of the film prior to the antistatic treatment so as to uniformly apply the antistatic agent. Particularly, corona discharge treatment is preferred, which can be conducted at low cost.

When a surfactant type antistatic agent is applied to the surface of the sealant layer to impart electrical conductivity, the amount of solid content of the applied antistatic agent is preferably from 3 to 20 mg/m², more preferably from 5 to 10 mg/m². If the amount of solid content of the applied antistatic agent is less than 3 mg/m², it tends to be difficult to remove electric charge when the cover film is charged, very small electronic components in the package are likely to adhere to the cover film when the cover film is peeled off from the carrier tape, thus leading to troubles in mounting. On the other hand, if the amount exceeds 20 mg/m², heat sealing properties to the carrier tape are likely to decrease.

To the sealant layer, spherical or ground particles of e.g. organic particles such as acrylic particles, styrene particles or silicone particles or inorganic particles such as talc particles, silica particles or mica particles, may be added so as to prevent blocking when the cover film is wound. Particularly, acrylic particles, talc particles, silica particles or the like can be suitably used, which are less likely to bring about a decrease in transparency when added.

The particles added have a mass average particle size of preferably from 1 to 20 μm, more preferably from 2 to 10 μm. If the mass average particle size is less than 1 μm, no sufficient effect of preventing blocking by addition of the particles may be obtained in some cases. On the other hand, if it exceeds 20 μm, although a favorable effect of preventing blocking will be obtained, addition in a large amount is required to prevent blocking, thus leading to an increase in the cost, and further, visible irregularities will be generated on the surface of the sealant layer of the cover film, thus deteriorating the outer appearance of the cover film.

The amount of addition of the particles to 100 parts by mass of the resin of the sealant layer is preferably from 5 to 25 parts by mass, more preferably from 10 to 20 parts by mass in the case of organic particles. In the case of inorganic particles, it is preferably from 10 to 40 parts by mass, more preferably from 15 to 35 parts by mass. If the addition amount of particles is smaller than the above amount, no sufficient effect of preventing blocking by addition of the particles is obtained in some cases, and if the amount of addition of the particles is larger than the above amount, a decrease in transparency of the cover film or a decrease in heat sealing properties may be brought about.

The surface of the sealant layer may be mechanically roughened for the purpose of suppressing blocking when the cover film is wound. The surface roughness is preferably at least 0.3 μm and at most 2.0 μm by the number average surface roughness (Ra), more preferably at least 0.5 μm and at most 1.5 μm. If the number average surface roughness is less than 0.3 μm, the effect of suppressing blocking by surface roughening is insufficient in some cases. On the other hand, if it exceeds 2.0 μm, the appearance of the film may be deteriorated or the cloudiness may increase, whereby numbers marked on components in the package are difficult to recognize.

A surface roughening method may be a method of re-heating a formed film, and pressing a roll of which the surface is roughened to the sealant surface of the film to transfer the roughness on the roll, or a method wherein when the melt-extruded resin for the sealant layer is sandwiched between two pressure rolls and pulled, the pressure rolls are preliminarily roughened so that the roughness on the roll is transferred. Further, a method may be mentioned wherein to the surface of the sealant layer of the cover film, a dispersion in a solvent of spherical or ground particles of e.g. organic fine particles such as acrylic fine particles, styrene fine particles or silicone fine particles or inorganic particles such as talc particles, silica particles or mica particles, is applied, and then the solvent is heated and volatilized.

A method of producing the film is not particularly limited, and the method may, for example, be a method wherein resins constituting the sealant layer are blended by using a mixer such as a Henschel mixer, a tumbler mixer or a mazelar, and the blended product is directly formed into a film for a sealant layer by extrusion, or the blended product is once extruded by a single screw or twin screw extruder to form pellets, which are formed into a film by extrusion, and the obtained film is bonded to a biaxially oriented film for the substrate layer by dry lamination method. Otherwise, a method may be mentioned wherein a monolayer film for the sealant layer formed by extrusion, is bonded to a biaxially oriented film for the substrate layer via a polyethylene resin.

As a method of forming a film for the sealant layer, any method of inflation method, T-die method, casting method, calender method, etc. may be used, but usually T-die method is employed. Further, as another method, resins constituting the sealant layer, and a polyolefin resin are separately melt-kneaded by using a single screw or twin screw extruder, and the two kneaded products are laminated by means of a feed block or a multi-manifold die and co-extruded by a T-die to obtain a two-layer film consisting of a sealant layer and a polyolefin layer, which is bonded to a biaxially oriented film for the sealant layer by dry lamination method or extrusion lamination method. It is possible to prevent adhesion of both sides of the film when the formed film is wound, i.e. so-called blocking by the structure of a two layer film.

It is also possible to obtain a cover film by applying an anchor coating agent of e.g. a polyurethane, a polyolefin, an ethylene/vinyl acetate resin or an ethylene/acrylic ester to the biaxially oriented film, and laminating a resin for the sealant layer in a molten state extruded from a T-die on the surface to which the anchor coating agent is applied.

As a film producing machine, a common laminator can be used, and a tandem laminator may also be used. As a coater to apply an anchor coating agent to the biaxially oriented polyester film at the time of extrusion lamination, dry lamination or extrusion coating, a commonly used coater such as a roll coater, a gravure coater, a reverse-roll coater, a bar coater or a dye coater may be used.

The thickness of the entire cover film is suitably from 40 to 90 μm, preferably from 50 to 70 μm, and the thickness of the biaxially oriented film is suitably from 9 to 50 μm, preferably from 12 to 25 μm. If the thickness of the entire cover film is less than 40 μm, the cover film is difficult to handle since it is thin, and the cover film is likely to be broken when it is peeled off. On the other hand, if the thickness of the entire cover film exceeds 90 μm, heat sealing tends to be difficult. If the thickness of the biaxially oriented film is less than 9 μm, the cover film is likely to be broken when it is peeled off.

In the cover film of the present invention, the interlayer may be provided between the substrate layer and the sealant layer in addition to the substrate layer consisting of a biaxially oriented film and the sealant layer. For example, a laminate having a structure of substrate layer consisting of a biaxially oriented film/polyolefin resin layer/sealant layer may be suitably used. By the interlayer, the adhesion strength between the substrate layer and the sealant layer will improve.

For the interlayer, a low density polyethylene resin, a linear low density polyethylene resin, a random copolymer resin of ethylene and 1-butene, a block copolymer resin of an aromatic vinyl compound and a conjugated diene type hydrocarbon compound, or a hydrogenated resin of a block copolymer of an aromatic vinyl compound and a conjugated diene type hydrocarbon compound may be suitably used. Further, another layer may be inserted between the layers for the cover film within a range not to impair the object of the present invention.

When heat sealing is carried out using the cover film as a cover, as a base material, a component packaging tape having dents in which electronic components are contained at regular intervals, such as a carrier tape, may be used. The material of the base material is not particularly limited, and a polystyrene, a polyvinyl chloride, a polycarbonate, a polyester or a polypropylene may, for example, be used.

By use of the cover film of the present invention, electronic components can be prevented from being stained during storage, transportation and mounting of the electronic components, and the cover film is excellent in heat sealing properties to easily obtain practical peel strength, and easy-opening properties to easily take out the electronic components. It is particularly excellent in heat sealing properties to a carrier tape made of a polycarbonate, and thus the time during which a sealing iron is pressed at the time of heat sealing is short and high speed sealing is possible with it.

### EXAMPLES

Now, the present invention will be described in further detail with reference to Examples. However, it should be understood that the present invention is by no means restricted thereto.

Resins (a), polyolefin resins (b) and antistatic agents used in Examples and Comparative Examples are as follows.

Resin (a) 1-1: A hydrogenated resin of styrene/butadiene/styrene triblock copolymer (“Tuftec H1041”, manufactured by Asahi Kasei Chemicals Corporation, styrene content of 30 mass %, butadiene content of 70 mass %, flowability of 5 g/10 min at a temperature of 230° C. under a load of 2.16 kg).

Resin (a) 1-2: A resin obtained by adding 12 parts by mass of crosslinked acrylic particles (“Ganzpearl GM0449”, manufactured by GANZ CHEMICAL CO., LTD., weight average particle size of 4 μm) to 100 parts by mass of a hydrogenated resin of a styrene/butadiene/styrene triblock copolymer (“Tuftec H1041”, manufactured by Asahi Kasei Chemicals Corporation, styrene content of 30 mass %, butadiene content of 70 mass %, flowability of 5 g/10 min at a temperature of 230° C. under a load of 2.16 kg) and kneading them by a twin screw extruder.

Resin (a) 1-3: A resin obtained by adding 20 parts by mass of crosslinked acrylic particles (“Ganzpearl GM0849”, manufactured by GANZ CHEMICAL CO., LTD., weight average particle size of 8 μm) to 100 parts by mass of a hydrogenated resin of a styrene/butadiene/styrene triblock copolymer (“Tuftec H1041”, manufactured by Asahi Kasei Chemicals Corporation, styrene content of 30 mass %, butadiene content of 70 mass %, flowability of 5 g/10 min at a temperature of 230° C. under a load of 2.16 kg) and kneading them by a twin screw extruder.

Resin (a) 1-4: A resin obtained by adding 25 parts by mass of talc particles (“MICRO ACE K-1”, manufactured by NIPPON TALC Co., Ltd., average particle size of 7.4 μm by laser diffraction method) to 100 parts by mass of a hydrogenated resin of a styrene/butadiene/styrene triblock copolymer (“Tuftec H1041”, manufactured by Asahi Kasei Chemicals Corporation, styrene content of 30 mass %, butadiene content of 70 mass %, flowability of 5 g/10 min at a temperature of 230° C. under a load of 2.16 kg) and kneading the mixture by a twin screw extruder.

Resin (a) 1-5: A hydrogenated resin of a styrene/butadiene/styrene triblock copolymer (“Tuftec H1053”, manufactured by Asahi Kasei Chemicals Corporation, styrene content of 29 mass %, butadiene content of 71 mass %, flowability of 1.8 g/10 min at a temperature of 230° C. under a load of 2.16 kg).

Resin (a) 1-6: A hydrogenated resin of a styrene/butadiene/styrene triblock copolymer (“Tuftec H1052”, manufactured by Asahi Kasei Chemicals Corporation, styrene content of 20 mass %, butadiene content of 80 mass %, flowability of 13 g/10 min at a temperature of 230° C. under a load of 2.16 kg).

Resin (a) 1-7: A hydrogenated resin of a styrene/isoprene/styrene triblock copolymer (“SEPTON 2007”, manufactured by KURARAY CO., LTD., styrene content of 30 mass %, butadiene content of 70 mass %, flowability of 2.4 g/10 min at a temperature of 230° C. under a load of 2.16 kg).

Resin (a) 1-8: A resin (styrene content of 36 mass %, butadiene content of 64 mass %, flowability of 3.3 g/10 min at a temperature of 230° C. under a load of 2.16 kg) obtained by mixing 50 mass % of a hydrogenated resin of a styrene/butadiene/styrene triblock copolymer (“Tuftec H1051”, manufactured by Asahi Kasei Chemicals Corporation, styrene content of 42 mass %, butadiene content of 58 mass %, flowability of 0.8 g/10 min at a temperature of 230° C. under a load of 2.16 kg) and 50 mass % of a hydrogenated resin of a styrene/butadiene/styrene triblock copolymer (“Tuftec H1041”, manufactured by Asahi Kasei Chemicals Corporation) and kneading the mixture by a twin screw extruder.

Resin (a) 1-9: A resin (styrene content of 45 mass %, butadiene content of 55 mass %, flowability of 3.5 g/10 min at a temperature of 230° C. under a load of 2.16 kg) obtained by mixing 40 mass % of a hydrogenated resin of a styrene/butadiene/styrene triblock copolymer (“Tuftec H1043”, manufactured by Asahi Kasei Chemicals Corporation, styrene content of 67 mass %, butadiene content of 33 mass %, flowability of 2 g/10 min at a temperature of 230° C. under a load of 2.16 kg) and 60 mass % of a hydrogenated resin of a styrene/butadiene/styrene triblock copolymer (“Tuftec H1041”, manufactured by Asahi Kasei Chemicals Corporation) and kneading the mixture by a twin screw extruder.

Resin (a) 1-10: A resin (styrene content of 30 mass %, butadiene content of 70 mass %, flowability of 19.5 g/10 min at a temperature of 230° C. under a load of 2.16 kg) obtained by mixing 70 mass % of a hydrogenated resin of a styrene/butadiene/styrene triblock copolymer (“Tuftec H1031”, manufactured by Asahi Kasei Chemicals Corporation, styrene content of 30 mass %, butadiene content of 70 mass %, flowability of 150 g/10 min at a temperature of 230° C. under a load of 2.16 kg) and 60 mass % of a hydrogenated resin of a styrene/butadiene/styrene triblock copolymer (“Tuftec H1041”, manufactured by Asahi Kasei Chemicals Corporation) and kneading the mixture by a twin screw extruder.

Resin (a) 1-11: A hydrogenated resin of a styrene/butadiene/styrene triblock copolymer (“Tuftec H1043”, manufactured by Asahi Kasei Chemicals Corporation, styrene content of 67 mass %, butadiene content of 33 mass %, flowability of 2 g/10 min at a temperature of 230° C. under a load of 2.16 kg).

Resin (a) 1-12: A hydrogenated resin of a styrene/butadiene/styrene triblock copolymer (“Tuftec H1062”, manufactured by Asahi Kasei Chemicals Corporation, styrene content of 18 mass %, butadiene content of 82 mass %, flowability of 4.5 g/10 min at a temperature of 230° C. under a load of 2.16 kg).

Resin (a) 1-13: A hydrogenated resin of a styrene/butadiene/styrene triblock copolymer (“Tuftec H1141”, manufactured by Asahi Kasei Chemicals Corporation, styrene content of 30 mass %, butadiene content of 70 mass %, flowability of 140 g/10 min at a temperature of 230° C. under a load of 2.16 kg).

Resin (a) 1-14: A resin (styrene content of 30 mass %, butadiene content of 70 mass %, flowability of 26 g/10 min at a temperature of 230° C. under a load of 2.16 kg) obtained by mixing 70 mass % of “Tuftec H1041” and 30 mass % of “Tuftec H1141” and kneading the mixture by a twin screw extruder.

Resin (a) 1-15: A hydrogenated resin of a styrene/butadiene/styrene triblock copolymer (“Kraton G1650”, manufactured by Kraton Polymers, styrene content of 30 mass %, butadiene content of 70 mass %, flowability of 0.5 g/10 min at a temperature of 230° C. under a load of 2.16 kg).

Resin (a) 2-1: A hydrogenated resin of a styrene/butadiene/styrene triblock copolymer (“Tuftec H1051”, manufactured by Asahi Kasei Chemicals Corporation, styrene content of 42 mass %, butadiene content of 58 mass %, flowability of 0.8 g/10 min at a temperature of 230° C. under a load of 2.16 kg).

Resin (a) 2-2: A hydrogenated resin of a styrene/butadiene/styrene triblock copolymer (“Tuftec H1062”, manufactured by Asahi Kasei Chemicals Corporation, styrene content of 18 mass %, butadiene content of 82 mass %, flowability of 4.5 g/10 min at a temperature of 230° C. under a load of 2.16 kg).

Resin (a) 2-3: A resin (styrene content of 50 mass %, butadiene content of 50 mass %, flowability of 3.7 g/10 min at a temperature of 230° C. under a load of 2.16 kg) obtained by mixing 50 mass % of a hydrogenated resin of a styrene/butadiene/styrene triblock copolymer (“Tuftec H1043”, manufactured by Asahi Kasei Chemicals Corporation, styrene content of 67 mass %, butadiene content of 33 mass %, flowability of 2.0 g/10 min at a temperature of 230° C. under a load of 2.16 kg) and 50 mass % of a hydrogenated resin of a styrene/butadiene/styrene triblock copolymer (“Tuftec H1041”, manufactured by Asahi Kasei Chemicals Corporation) and kneading the mixture by a twin screw extruder.

Resin (b) 1-1: An ethylene/1-butene random copolymer resin (“TAFMER”, manufactured by Mitsui Chemicals Inc., flowability of 0.5 g/10 min at a temperature of 230° C. under a load of 2.16 kg).

Resin (b) 1-2: A low density polyethylene (“Novatec LC”, manufactured by Japan Polyethylene Corporation, flowability of 2.5 g/10 min at a temperature of 230° C. under a load of 2.16 kg).

Resin (b) 1-3: An ethylene/vinyl acetate copolymer resin (“EVAFLEX”, manufactured by DU PONT-MITSUI POLYCHEMICALS CO., LTD., vinyl acetate content of 19 mass %, flowability of 8 g/10 min at a temperature of 230° C. under a load of 2.16 kg).

Resin (b) 1-4: An ethylene/methyl acrylate copolymer resin (“REXPEARL EMA”, manufactured by Japan Polyethylene Corporation, methyl acrylate content of 20 mass %, flowability of 6.5 g/10 min at a temperature of 230° C. under a load of 2.16 kg).

Resin (b) 1-5: An ethylene/1-butene random copolymer resin (“TAFMER”, manufactured by Mitsui Chemicals Inc., flowability of 18 g/10 min at a temperature of 230° C. under a load of 2.16 kg).

Resin (b) 1-6: A linear low density polyethylene (“ULTZEX”, manufactured by PRIME POLYMER, flowability of 12 g/10 min at a temperature of 230° C. under a load of 2.16 kg).

Resin (b) 2-1: A linear low density polyethylene resin (“KERNEL KF260T”, manufactured by Japan Polyethylene Corporation, elastic modulus at 25° C. of 7.21×10⁷ Pa, melting point of 93° C., flowability of 2.0 g/10 min at a temperature of 230° C. under a load of 2.16 kgf).

Resin (b) 2-2: An ethylene/methyl acrylate random copolymer resin (“REXPEARL EB230X”, manufactured by Japan Polyethylene Corporation, ratio of methyl acrylate of 12 mass %, elastic modulus at 25° C. of 5.38×10⁷ Pa, melting point of 90° C., flowability of 6.0 g/10 min at a temperature of 230° C. under a load of 2.16 kgf).

Resin (b) 2-3: An ethylene/methyl acrylate random copolymer resin (“ELVALOY 1209AC”, manufactured by DU PONT-MITSUI POLYCHEMICALS CO., LTD., elastic modulus at 25° C. of 5.69×10⁷ Pa, melting point of 101° C., flowability of 2.0 g/10 min at a temperature of 230° C. under a load of 2.16 kgf).

Resin (b) 2-4: An ethylene/vinyl acetate copolymer resin (“EVAFLEX EV460”, manufactured by DU PONT-MITSUI POLYCHEMICALS CO., LTD., ratio of vinyl acetate of 19 mass %, elastic modulus at 25° C. of 4.97×10⁷ Pa, melting point of 84° C., flowability of 2.5 g/10 min at a temperature of 230° C. under a load of 2.16 kgf).

Resin (b) 2-5: An ethylene/ethyl acrylate random copolymer resin (“REXPEARL A1150”, manufactured by Japan Polyethylene Corporation, ratio of ethyl acrylate of 15 mass %, elastic modulus at 25° C. of 4.64×10⁷ Pa, melting point of 100° C., flowability of 0.8 g/10 min at a temperature of 230° C. under a load of 2.16 kgf).

Resin (b) 2-6: An ethylene/n-butyl acrylate random copolymer resin (“ELVALOY 3117AC”, manufactured by DU PONT-MITSUI POLYCHEMICALS CO., LTD., ratio of n-butyl acrylate of 17 mass %, elastic modulus at 25° C. of 4.21×10⁷ Pa, melting point of 99° C., flowability of 1.5 g/10 min at a temperature of 230° C. under a load of 2.16 kgf).

Resin (b) 2-7: A linear low density polyethylene resin (“Novatec C6 SF840”, manufactured by Japan Polyethylene Corporation, elastic modulus at 25° C. of 3.44×10⁸ Pa, melting point of 128° C., flowability of 2.8 g/10 min at a temperature of 230° C. under a load of 2.16 kgf).

Resin (b) 2-8: A linear low density polyethylene resin (“HARMOREX NF464N”, manufactured by Japan Polyethylene Corporation, elastic modulus at 25° C. of 1.99×10⁸ Pa, melting point of 124° C., flowability of 3.5 g/10 min at a temperature of 230° C. under a load of 2.16 kgf).

Resin (b) 2-9: A low density polyethylene resin (“Novatec LD LF441MD”, manufactured by Japan Polyethylene Corporation, elastic modulus at 25° C. of 1.28×10⁸ Pa, melting point of 113° C., flowability of 2.0 g/10 min at a temperature of 230° C. under a load of 2.16 kgf).

Resin (b) 2-10: An ethylene/methyl acrylate random copolymer resin (“REXPEARL EB050S”, manufactured by Japan Polyethylene Corporation, ratio of methyl acrylate of 24 mass %, elastic modulus at 25° C. of 3.87×10⁷ Pa, melting point of 87° C., flowability of 2.0 g/10 min at a temperature of 230° C. under a load of 2.16 kgf).

Resin (b) 2-11: An ethylene/vinyl acetate random copolymer resin (“EVAFLEX EV450”, manufactured by DU PONT-MITSUI POLYCHEMICALS CO., LTD., ratio of vinyl acetate of 19 mass %, elastic modulus at 25° C. of 1.05×10⁷ Pa, melting point of 77° C., flowability of 15 g/10 min at a temperature of 230° C. under a load of 2.16 kgf).

Resin (b) 2-12: An ethylene/ethyl acrylate random copolymer resin (“EVAFLEX A-707”, manufactured by DU PONT-MITSUI POLYCHEMICALS CO., LTD., ratio of ethyl acrylate of 17 mass %, elastic modulus at 25° C. of 1.03×10⁷ Pa, melting point of 77° C., flowability of 25 g/10 min at a temperature of 230° C. under a load of 2.16 kgf).

Resin (b) 2-13: A high density polyethylene resin (“Novatec HD HJ560”, manufactured by Japan Polyethylene Corporation, elastic modulus at 25° C. of 1.24×10⁹ Pa, melting point of 136° C., flowability of 7 g/10 min at a temperature of 230° C. under a load of 2.16 kgf).

Resin (b) 2-14: A linear low density polyethylene resin (“KERNEL KS240T”, manufactured by Japan Polyethylene Corporation, elastic modulus at 25° C. of 2.55×10⁷ Pa, melting point of 60° C., flowability of 2.2 g/10 min at a temperature of 230° C. under a load of 2.16 kgf).

Resin (b) 2-15: An ethylene/1-butene random copolymer resin (“TAFMER A4085”, manufactured by Mitsui Chemicals Inc., elastic modulus at 25° C. of 1.85×10⁷ Pa, melting point of 70° C., flowability of 3.5 g/10 min at a temperature of 230° C. under a load of 2.16 kgf).

Resin (b) 2-16: An ethylene/ethyl acrylate random copolymer resin (“EVAFLEX A-704”, manufactured by DU PONT-MITSUI POLYCHEMICALS CO., LTD., ratio of ethyl acrylate of 25 mass %, elastic modulus at 25° C. of 8.97×10⁶ Pa, melting point of 68° C., flowability of 27 g/10 min at a temperature of 230° C. under a load of 2.16 kgf).

Resin (b) 2-17: A linear low density polyethylene resin (“KERNEL KC650T”, manufactured by Japan Polyethylene Corporation, elastic modulus at 25° C. of 3.55×10⁷ Pa, melting point of 55° C., flowability of 20 g/10 min at a temperature of 230° C. under a load of 2.16 kgf).

Antistatic agent 1-1: A cationic antistatic agent (“ELEGAN”, manufactured by NOF CORPORATION).

Antistatic agent 1-2: An anionic antistatic agent (“LIPOMIN”, manufactured by LION CORPORATION).

Antistatic agent 2-1: A cationic antistatic agent (“Electrostripper QN”, manufactured by Kao Corporation).

### Example 1-1

Hydrogenated resin (a) 1-1 of a styrene/butadiene/styrene triblock copolymer (“Tuftec H1041”, manufactured by Asahi Kasei Chemicals Corporation, styrene content of 30 mass %, butadiene content of 70 mass %, flowability of 5 g/10 min at a temperature of 230° C. under a load of 2.16 kg) for the sealant layer and 100 mass % of a low density polyethylene (“UBE Polyethylene R-500”, manufactured by Ube Maruzen Polyethylene Co., Ltd.) as a polyolefin resin for the interlayer were extruded from separate single screw extruders and laminated by a feed block to obtain a two-layer film with a thickness of the sealant layer consisting of the hydrogenated product of a styrene/butadiene/styrene triblock copolymer of 15 μm, a thickness of the polyolefin of 20 μm and a total thickness of 35 μm by T-die method. This two-layer film was laminated on a biaxially oriented polyethylene terephthalate film (thickness 16 μm) to which an urethane type anchor coating agent was applied, via a polyolefin resin (“Novatec LC”, manufactured by Japan Polyethylene Corporation) by extrusion lamination method to obtain a cover film for an electronic component carrier tape. It was evaluated and the results are shown in Table 1-1.

### Examples 1-2 to 1-4 and Comparative Example 1-5

Using the above resins, cover films for a carrier tape are prepared in the same manner as in Example 1-1 with blend ratios shown in Tables 1-1 and 1-4. The cover films were evaluated and the results are shown in Tables 1-1 and 1-4.

### Example 1-5

Hydrogenated resin (a) 1-5 of a styrene/butadiene/styrene triblock copolymer (“Tuftec H1053”, manufactured by Asahi Kasei Chemicals Corporation, styrene content of 29 mass %, butadiene content of 71 mass %, flowability of 1.8 g/10 min at a temperature of 230° C. under a load of 2.16 kg) for the sealant layer and 100 mass % of a low density polyethylene (“UBE Polyethylene R-500”, manufactured by Ube Maruzen Polyethylene Co., Ltd.) as a polyolefin resin for the interlayer were extruded from separate single screw extruders and laminated by a feed block to obtain a two-layer film with a thickness of the sealant layer consisting of the hydrogenated product of a styrene/butadiene/styrene triblock copolymer of 15 μm, a thickness of the polyolefin of 20 μm and a total thickness of 35 μm by T-die method. This two-layer film was laminated on a biaxially oriented polyethylene terephthalate film (thickness 16 μm) to which an urethane type anchor coating agent was applied, via a polyethylene resin (“Novatec LC”, manufactured by Japan Polyethylene Corporation) by extrusion lamination method to obtain a cover film for an electronic component carrier tape. Then, corona discharge treatment was applied and a cationic antistatic agent (“ELEGAN”, manufactured by NOF CORPORATION) was applied to the surface of the polyethylene terephthalate film and the sealant surface of the cover film to obtain a cover film subjected to antistatic treatment. The cover film was evaluated and the results are shown in Table 1-1.

### Examples 1-6, 1-7, 1-11, 1-23 and 1-24 and Comparative Examples 1-1 to 1-4

Using the above resins, cover films for a carrier tape were prepared in the same manner as in Example 1-5 with blend ratios shown in Tables 1-1, 1-2, 1-3 and 1-4. The cover films were evaluated and the results are shown in Tables 1-1, 1-2, 1-3 and 1-4.

### Example 1-8

Hydrogenated resin (a) 1-8 of a styrene/butadiene/styrene triblock copolymer (a mixed resin of 50 mass % of “Tuftec H1051”, manufactured by Asahi Kasei Chemicals Corporation, styrene content of 42 mass %, butadiene content of 58 mass %, flowability of 0.8 g/10 min at a temperature of 230° C. under a load of 2.16 kg; and 50 mass % of “Tuftec H1041”, manufactured by Asahi Kasei Chemicals Corporation) was extruded from a single screw extruder onto a biaxially oriented polyethylene terephthalate film (thickness 25 μm) to which an urethane type anchor coating agent was applied to obtain a cover film for an electronic component carrier tape. Then, corona discharge treatment was applied and a cationic antistatic agent (“ELEGAN”, manufactured by NOF CORPORATION) was applied to the surface of the polyethylene terephthalate film and the sealant surface of the cover film to obtain a cover film subjected to antistatic treatment. The cover film was evaluated and the results are shown in Table 1-1.

### Examples 1-9, 1-10 and 1-12 to 1-14

Using the above resins, cover films for a carrier tape were prepared in the same manner as in Example 1-8 with blend ratios shown in Tables 1-1 and 1-2. The cover films were evaluated and the results are shown in Tables 1-1 and 1-2.

### Example 1-15

A mixture of 99 mass % of hydrogenated resin (a) 1-1 of a styrene/butadiene/styrene triblock copolymer (“Tuftec H1041”, manufactured by Asahi Kasei Chemicals Corporation, styrene content of 30 mass %, butadiene content of 70 mass %, flowability of 5 g/10 min at a temperature of 230° C. under a load of 2.16 kg) and 1 mass % of ethylene/1-butene random copolymer resin (b) 1-1 (“TAFMER”, manufactured by Mitsui Chemicals Inc., flowability of 0.5 g/10 min at a temperature of 230° C. under a load of 2.16 kg) for the sealant layer and 100 mass % of a low density polyethylene (“UBE Polyethylene R-500”, manufactured by Ube Maruzen Polyethylene Co., Ltd.) as a polyolefin resin for the interlayer were extruded from separate single screw extruders and laminated by a feed block to obtain a two-layer film with a thickness of the sealant layer consisting of the hydrogenated product of a styrene/butadiene/styrene triblock copolymer and the ethylene/1-butene random copolymer resin of 20 μm, a thickness of the polyolefin of 20 μm and a total thickness of 40 μm by T-die method. This two-layer film was laminated on a biaxially oriented polyethylene terephthalate film (thickness 16 μm) to which an urethane type anchor coating agent was applied, via a polyethylene resin (“Novatec LC”, manufactured by Japan Polyethylene Corporation) by extrusion lamination method to obtain a cover film for an electronic component carrier tape.

Then, corona discharge treatment was applied and a cationic antistatic agent (“ELEGAN”, manufactured by NOF CORPORATION) was applied to the surface of the polyethylene terephthalate film and the sealant surface is of the cover film to obtain a cover film subjected to antistatic treatment. The cover film was evaluated and the results are shown in Table 1-2.

### Examples 1-16, 1-17 and 1-25 to 1-27

Using the above resins, cover films for a carrier tape were prepared in the same manner as in Example 1-15 with blend ratios shown in Tables 1-2 and 1-3. The cover films were evaluated and the results are shown in Tables 1-2 and 1-3.

### Example 1-18

A resin mixture of 85 mass % of hydrogenated resin (a) 1-1 of a styrene/butadiene/styrene triblock copolymer and 15 mass % of low density polyethylene (b) 1-2 (“Novatec LC”, manufactured by Japan Polyethylene Corporation, flowability of 2.5 g/10 min at a temperature of 230° C. under a load of 2.16 kg) for the sealant layer was extruded from a single screw extruder onto a biaxially oriented polyethylene terephthalate film (thickness 25 μm) to which an urethane type anchor coating agent was applied to obtain a cover film for an electronic component carrier tape. Then, corona discharge treatment was applied and a cationic antistatic agent (“ELEGAN”, manufactured by NOF CORPORATION) was applied to the surface of the polyethylene terephthalate film and the sealant surface of the cover film to obtain a cover film subjected to antistatic treatment. The cover film was evaluated and the results are shown in is Table 1-2.

### Examples 1-19 to 1-22 and Comparative Examples 1-6 to 1-9

Using the above resins, cover films for a carrier tape were prepared in the same manner as in Example 1-18 with blend ratios shown in Tables 1-2, 1-3 and 1-4. The cover films were evaluated and the results are shown in Tables 1-2, 1-3 and 1-4.

### Example 1-28

A hydrogenated resin of a styrene/butadiene/styrene triblock copolymer (“Tuftec H1041”, manufactured by Asahi Kasei Chemicals Corporation) as a resin for the interlayer was extruded from a single screw extruder onto a biaxially oriented polyethylene terephthalate film (thickness 16 μm) to which an urethane type anchor coating agent was applied, with a thickness of 20 μm to prepare a two-layer film comprising the polyethylene terephthalate film and the hydrogenated resin of a styrene/butadiene/styrene triblock copolymer. Then, as the sealant layer, hydrogenated resin (a) 1-2 of a styrene/butadiene/styrene triblock copolymer containing 12 mass % of crosslinked acrylic particles was extruded from a single screw extruder onto the hydrogenated resin of a styrene/butadiene/styrene triblock copolymer of the two-layer film, with a thickness of 20 μm, to obtain a cover film for an electronic component carrier tape. The cover film was evaluated and the results are shown in Table 1-3.

### Example 1-29

Using the above resin, a cover tape for a carrier tape was prepared in the same manner as in Example 1-28 with a blend ratio shown in Table 1-4. The cover film was evaluated and the results are shown in Table 1-3.

### Example 2-1

On a biaxially oriented polyester film (thickness 16 μm) to which an urethane type anchor coating agent was applied, an urethane type anchor coating agent was applied by gravure method, and a low density polyethylene resin (“Novatec LC600A”, manufactured by Japan Polyethylene Corporation) extruded from a T-die was applied onto a polyester film, with a thickness of 13 μm, to prepare a two-layer film comprising the polyester film and a layer of a low density polyethylene resin. Then, for the sealant layer, 90 mass % of hydrogenated resin (a) 1-1 of a styrene/butadiene/styrene triblock copolymer (“Tuftec H1041”, manufactured by Asahi Kasei Chemicals Corporation, styrene content of 30 mass %, butadiene content of 70 mass %, flowability of 5.0 g/10 min at a temperature of 230° C. under a load of 2.16 kg) and 10 mass % of a linear low density polyethylene (“KERNEL KF260T”, manufactured by Japan Polyethylene Corporation, elastic modulus at 25° C. of 7.21×10⁷ Pa, melting point of 93° C.) as polyolefin resin (b) 2-1 were pre-blended in a tumbler and extruded from a single screw extruder with a diameter of 50 mm onto the low density polyethylene layer of the above-prepared two-layer film comprising the polyester film and the layer of a low density polyethylene resin, to obtain a cover film comprising the polyester film, the low density polyethylene layer as the interlayer and the sealant layer before application of an antistatic agent. Then, to both sides of the cover film, a solution having an amphoteric antistatic agent (“Electrostripper QN”, manufactured by Kao Corporation) diluted with pure water 50 times was applied by gravure coating method to obtain a cover film for an electronic component carrier tape having antistatic properties. The amount of the antistatic agent applied was 7 mg/m² as calculated from the loss of the antistatic agent solution and the area of the cover film used for application. The cover film was evaluated and the results are shown in Table 2-1.

### Examples 2-2 to 2-26 and Comparative Examples 2-1 to 2-5

Using the above resins, cover films for a carrier tape were prepared in the same manner as in Example 2-1 with blend ratios shown in Tables 2-1, 2-2, 2-3 and 2-4. The cover films were evaluated and the results are shown in Tables 2-1, 2-2, 2-3 and 2-4.

### Example 2-27

For the sealant layer, 80 mass % of hydrogenated resin (a) 1-1 of a styrene/butadiene/styrene triblock copolymer (“Tuftec H1041”, manufactured by Asahi Kasei Chemicals Corporation, styrene content of 30 mass %, butadiene content of 70 mass %, flowability of 5.0 g/10 min at a temperature of 230° C. under a load of 2.16 kg) and 20 mass % of a linear low density polyethylene (“KERNEL KF260T”, manufactured by Japan Polyethylene Corporation, elastic modulus at 25° C. of 7.21×10⁷ Pa, melting point of 93° C.) as polyolefin resin (b) 2-1 were pre-blended in a tumbler and kneaded by a co-rotating twin screw extruder with a diameter of 45 mm to obtain a resin composition constituting the sealant layer. The resin composition and a low density polyethylene resin (“R-500”, manufactured by Ube Maruzen Polyethylene Co., Ltd.) were extruded from separate extruders and laminated by a multi-manifold die to prepare a two-layer film with a thickness of the sealant layer of 12 μm and a thickness of the layer made of the low density polyethylene R-500 of 23 μm. Then, the two-layer film was laminated on a biaxially oriented polyethylene terephthalate film (thickness 16 μm) to which an urethane type anchor coating agent was applied via a low density polyethylene resin (“Novatec LC”, manufactured by Japan Polyethylene Corporation, thickness 13 μm) to obtain a cover film before application of an antistatic agent. Then, to both sides of the cover film, a solution having a surfactant type antistatic agent (“Electrostripper QN”, manufactured by Kao Corporation) diluted with pure water 50 times was applied by gravure coating method to obtain a cover film for an electronic component carrier tape having antistatic properties. The amount of the antistatic agent applied was calculated from the loss of the antistatic agent solution and the area of the cover film used for application. The cover film was evaluated and the results are shown in Table 2-3.

### Example 2-28

Using the above resins, a cover film for a carrier tape was prepared in the same manner as in Example 2-27 with a blend ratio shown in Table 2-3. The cover film was evaluated and the results are shown in Table 2-3.

The following evaluations were conducted with respect to the cover films for an electronic component carrier tape prepared in Examples and Comparative Examples. The evaluation results are shown in Tables 1-1 to 1-4 and 2-1 to 2-4.

### (1-1) Film Forming Properties

Evaluation was made based on standards “good”: a change in the thickness of the film within ±20% when a film was formed in a method in Examples 1-1 to 1-29 and Comparative Examples 1-1 to 1-9, and “poor”: a change exceeding ±20%. The results are shown in the column of film forming properties in Tables 1-1 to 1-4.

### (1-2) Extrudability

Evaluation was made based on standards “excellent”: favorable film forming properties of the extruded sealant resin in a method of forming a sealant film in Example 2-1 and a distribution of a sealant thickness within ±10%, and “good”: poor elongation of the extruded sealant resin and a dispersion of the sealant thickness of ±10% or above. The results are shown in the column of extrudability in Tables 2-1 to 2-4.

### (2-1) Sealing Properties

The cover film with a width of 5.5 mm was heat sealed to a polycarbonate carrier tape (manufactured by Denki Kagaku Kogyo Kabushiki Kaisha) with a width of 8 mm using a taping machine (ST-60, manufactured by Systemation) under conditions of a seal head width of 0.5 mm×2, a seal head length of 32 mm, a sealing pressure of 3.5 MPa, a feed length of 16 mm and a sealing time of 0.2 sec×2 (double seal), at a sealing iron temperature of from 160° C. to 190° C. at intervals of 10° C. The heat sealed product was left at stand in an atmosphere at a temperature of 23° C. at a relative humidity of 50% for 24 hours, and then the cover film was peeled off at a rate of 300 mm per minute at a peeling angle of 180° by using a peel back force tester (VG-20, manufactured by Vanguard Systems Inc.) in an atmosphere at a temperature of 23° C. at a relative humidity of 50%. Evaluation was made based on standards “excellent”: an average peel strength within a range of from 0.3 to 0.9 N when the cover film was heat sealed at sealing iron temperatures of 160° C. and 190° C., “good”: an average peel strength within a rage of from 0.3 to 0.9 N when the cover film was heat sealed at sealing iron temperature of either 160° C. or 190° C., and “poor”: an average peel strength other than the above. Further, a case such that film forming properties were poor and no film could be obtained, whereby sealing properties could not be evaluated, is marked by “not evaluated”. The results are shown in the column of sealing properties in Tables 1-1 to 1-4.

### (2-2) Sealing Properties

The cover film with a width of 5.5 mm was heat sealed to a polystyrene carrier tape (manufactured by Denki Kagaku Kogyo Kabushiki Kaisha) with a width of 8 mm by using a taping machine (ST-60, manufactured by Systemation) under conditions of a seal head width of 0.5 mm×2, a seal head length of 32 mm, a sealing pressure of 3.5 MPa, a feed length of 16 mm and a sealing time of 0.5 sec×2 (double seal), at a sealing iron temperature of from 120° C. to 160° C. at intervals of 10° C. The heat sealed product was left at stand in an atmosphere at a temperature of 23° C. at a relative humidity of 50% for 24 hours, and then the cover film was peeled off at a rate of 300 mm per minute at a peeling angle of 180° by using a peel back force tester (VG-20, manufactured by Vanguard Systems Inc.) in an atmosphere at a temperature of 23° C. at a relative humidity of 50%. Evaluation was made based on standards “excellent”: an average peel strength within a range of from 0.3 to 0.9 N when the cover film was heat sealed at sealing iron temperatures of 120° C. and 160° C., whereby aimed peel strength can easily be obtained even if there is non-uniformity of the pressure of the sealing iron at the time of heat sealing, “good”: an average peel strength within a rage of from 0.3 to 0.9 N when the cover film was heat sealed at a sealing iron temperature of either 120° C. or 160° C., and “poor”: an average peel strength other than the above, whereby aimed peel strength is hardly obtained. The results are shown in the column of sealing properties in Tables 2-1 to 2-4.

### (3-1) Difference Between Maximum and Minimum Peel Strengths

The cover film with a width of 5.5 mm was heat sealed to a polystyrene carrier tape (manufactured by Sumitomo 3M Limited) with a width of 8 mm by using a taping machine (ST-60, manufactured by Systemation) under conditions of a seal head width of 0.5 mm×2, a seal head length of 32 mm, a sealing pressure of 3.5 MPa, a feed length of 16 mm and a sealing time of 0.2 sec×2 (double seal). The heat sealed product was left to stand in an atmosphere at a temperature of 23° C. at a relative humidity of 50% for 24 hours, and the temperature of a heat sealing iron was adjusted so that the average peel strength would be 0.4 N when the cover film was peeled off at a rate of 300 mm per minute at a peeling angle of 180° by using a peel back force tester (VG-20, manufactured by Vanguard Systems Inc.) in an atmosphere at a temperature of 23° C. at a relative humidity of 50%. Evaluation was made based on standards “excellent”: a difference between the maximum and minimum peel strengths of less than 0.2 N when the carrier tape in a length of 100 mm was peeled off, “good”: a difference of at least 0.2 N and less than 0.3 N, and “poor”: a difference of 0.3 N or more. Further, a case such that film forming properties were very poor, and no film could be obtained, whereby sealing properties could not be evaluated, is marked by “not evaluated”. The results are shown in the column of difference between maximum and minimum peel strengths in Tables 1-1 to 1-4.

### (3-2) Difference Between Maximum and Minimum Peel Strengths

The cover film with a width of 5.5 mm was heat sealed to a polystyrene carrier tape (manufactured by Denki Kagaku Kogyo Kabushiki Kaisha) with a width of 8 mm by using a taping machine (ST-60, manufactured by Systemation) under conditions of a seal head width of 0.5 mm×2, a seal head length of 32 mm, a sealing pressure of 3.5 MPa, a feed length of 16 mm and a sealing time of 0.5 sec×2 (double seal). The heat sealed product was left to stand in an atmosphere at a temperature of 23° C. at a relative humidity of 50% for 24 hours, and the temperature of a heat sealing iron was adjusted so that the average peel strength would be 0.4 N when the cover film was peeled off at a rate of 300 mm per minute at a peeling angle of 180° by using a peel back force tester (VG-20, manufactured by Vanguard Systems Inc.) in an atmosphere at a temperature of 23° C. at a relative humidity of 50%. Evaluation was made based on standards “excellent”: the difference between the maximum and minimum peel strengths is so small as less than 0.2 N when the carrier tape in a length of 100 mm was peeled off, whereby when the cover film is peeled off at the time of mounting, components in the package will hardly fly up, “good”: the difference is at least 0.2 N and less than 0.3 N, and “poor”: the difference is 0.3 N or more. The results are shown in the column of difference between maximum and minimum peel strengths in Tables 2-1 to 2-4.

### (4-1) Adhesion at Non-Sealing Portion

Evaluation was made based on standards “excellent”: when heat sealing was conducted under conditions in (3-1), no adhesion at a portion to which the sealing iron was not contacted was observed at all, “good”: although adhesion was observed immediately after sealing, the cover film was spontaneously peeled off within 5 minutes after the heat sealed product was left to stand in an environment at a temperature of 23° C. at a relative humidity of 50%, and “poor”: adhesion was observed for 5 minutes or longer. A case such that film forming properties were significantly poor, and no film was obtained, whereby evaluation could not be carried out, is marked by “not evaluated”. The results are shown in the column of adhesion at non-sealing portion in Tables 1-1 to 1-4.

### (4-2) Adhesion at Non-Sealing Portion

Evaluation was made based on standards “excellent”: when heat sealing was carried out under conditions in (3-2), no adhesion at a portion to which the sealing iron was not contacted was observed at all, “good”: although adhesion was observed immediately after sealing, the cover film was spontaneously peeled off within 5 minutes after the heat sealed product was left to stand in an environment at a temperature of 23° C. at a relative humidity of 50%, and “poor”: adhesion was observed for 5 minutes or longer, thus peeling of the cover film may be affected. The results are shown in the column of adhesion at non-sealing portion in Tables 2-1 to 2-4.

### (5) Surface Resistance

The surface resistance on the sealant surface was measured by using Hiresta UP MCP-HT40 manufactured by Mitsubishi Chemical Corporation by a method stipulated in JIS K6911 at an ambient temperature of 23° C. at an ambient humidity of 50% RH at an applied voltage of 500 V. The results are shown in the column of surface resistance in Tables 1-1 to 1-4 and 2-1 to 2-4.

(6) Stability of Peel Strength with Time

Under conditions of (2-2) test for sealing properties, the heat sealed product having a peel strength of 0.4 N was left to stand in an atmosphere of 60° C. for 24 hours or more and then left to stand in an atmosphere at a temperature of 23° C. at a relative humidity of 50% for 24 hours, and then the cover film was peeled at a rage of 300 mm per minute at a peeling angle of 180° by using a peel back force tester (VG-20, manufactured by Vanguard Systems Inc.) in an atmosphere at a temperature of 23° C. at a relative humidity of 50%. Evaluation was made based on standards “excellent”: a peel strength within a range of at least 0.3 N and less than 0.6 N, “good”: a peel strength within a range of at least 0.6 N and less than 0.8 N, and “poor”: a peel strength exceeding 0.8 N. The results are shown in the column of stability of peel strength with time in Tables 2-1 to 2-4.

The cover film according to the present invention is excellent in stability of peel strength at the time of peeling, and excellent heat sealing properties particularly heat sealing properties to a polycarbonate carrier tape. With the cover film of the present invention, the temperature range of a sealing iron is wide at the time of heat sealing, the time over which the sealing iron is pressed is short, and high speed sealing is possible.

TABLE 1-1

| | | Ex. 1-1 | Ex. 1-2 | Ex. 1-3 | Ex. 1-4 | Ex. 1-5 |
|---|---|---|---|---|---|---|
| Hydrogenated resin (a) of aromatic | Resin (a) 1-1 | 100 | | | | |
| vinyl compound and conjugated diene | Resin (a) 1-2 | | 100 | | | |
| type hydrocarbon compound; mass % | Resin (a) 1-3 | | | 100 | | |
| | Resin (a) 1-4 | | | | 100 | |
| | Resin (a) 1-5 | | | | | 100 |
| | Resin (a) 1-6 | | | | | |
| | Resin (a) 1-7 | | | | | |
| | Resin (a) 1-8 | | | | | |
| | Resin (a) 1-9 | | | | | |
| | Resin (a) 1-10 | | | | | |
| Polyolefin resin (b); mass % | Resin (b) 1-1 | | | | | |
| | Resin (b) 1-2 | | | | | |
| | Resin (b) 1-3 | | | | | |
| | Resin (b) 1-4 | | | | | |
| | Resin (b) 1-5 | | | | | |
| | Resin (b) 1-6 | | | | | |
| Antistatic agent; mg/m² | Antistatic | | | | | 8 |
| | agent 1-1 | | | | | |
| | Antistatic | | | | | |
| | agent 1-2 | | | | | |
| Substrate thickness; μm | | 16 | 16 | 16 | 16 | 16 |
| Thickness of polyolefin resin interlayer; μm | | 20 | 20 | 20 | 20 | 20 |
| Thickness of interlayer made of hydrogenated resin of | | — | — | — | — | — |
| styrene/butadiene/styrene triblock copolymer; μm | | | | | | |
| Sealant thickness; μm | | 15 | 15 | 15 | 15 | 15 |
| Total thickness of cover film; μm | | 51 | 51 | 51 | 51 | 51 |
| (1-1) Film forming properties | | Good | Good | Good | Good | Good |
| (2-1) Sealing properties | | Excellent | Excellent | Excellent | Excellent | Excellent |
| (3-1) Difference between maximum and minimum peel | | Excellent | Excellent | Excellent | Excellent | Excellent |
| strengths | | | | | | |
| (4-1) Adhesion at non-sealing portion | | Good | Excellent | Excellent | Excellent | Good |
| (5) Surface resistance; Ω | | >1 × 10¹⁴ | >1 × 10¹⁴ | >1 × 10¹⁴ | >1 × 10¹⁴ | 7.5 × 10¹⁰ |
| | | Ex. 1-6 | Ex. 1-7 | Ex. 1-8 | Ex. 1-9 | Ex. 1-10 |
| Hydrogenated resin (a) of aromatic | Resin (a) 1-1 | | | | | |
| vinyl compound and conjugated diene | Resin (a) 1-2 | | | | | |
| type hydrocarbon compound; mass % | Resin (a) 1-3 | | | | | |
| | Resin (a) 1-4 | | | | | |
| | Resin (a) 1-5 | | | | | |
| | Resin (a) 1-6 | 100 | | | | |
| | Resin (a) 1-7 | | 100 | | | |
| | Resin (a) 1-8 | | | 100 | | |
| | Resin (a) 1-9 | | | | 100 | |
| | Resin (a) 1-10 | | | | | 100 |
| Polyolefin resin (b); mass % | Resin (b) 1-1 | | | | | |
| | Resin (b) 1-2 | | | | | |
| | Resin (b) 1-3 | | | | | |
| | Resin (b) 1-4 | | | | | |
| | Resin (b) 1-5 | | | | | |
| | Resin (b) 1-6 | | | | | |
| Antistatic agent; mg/m² | Antistatic | 8 | 8 | 8 | 8 | 8 |
| | agent 1-1 | | | | | |
| | Antistatic | | | | | |
| | agent 1-2 | | | | | |

| | | | | | |
|---|---|---|---|---|---|
| Substrate thickness; μm | 16 | 16 | 25 | 25 | 25 |
| Thickness of polyolefin resin interlayer; μm | 20 | 20 | — | — | — |
| Thickness of interlayer made of hydrogenated resin of | — | — | — | — | — |
| styrene/butadiene/styrene triblock copolymer; μm | | | | | |
| Sealant thickness; μm | 15 | 15 | 20 | 20 | 20 |
| Total thickness of cover film; μm | 51 | 51 | 45 | 45 | 45 |
| (1-1) Film forming properties | Good | Good | Good | Good | Good |
| (2-1) Sealing properties | Excellent | Excellent | Excellent | Excellent | Excellent |
| (3-1) Difference between maximum and minimum peel | Excellent | Excellent | Good | Good | Excellent |
| strengths | | | | | |
| (4-1) Adhesion at non-sealing portion | Good | Good | Excellent | Excellent | Good |
| (5) Surface resistance; Ω | 8.3 × 10¹⁰ | 6.4 × 10¹⁰ | 8.8 × 10¹⁰ | 7.0 × 10¹⁰ | 6.1 × 10¹⁰ |

TABLE 1-2

| | | Ex. 1-11 | Ex. 1-12 | Ex. 1-13 | Ex. 1-14 | Ex. 1-15 |
|---|---|---|---|---|---|---|
| Hydrogenated resin (a) of aromatic | Resin (a) 1-1 | 100 | 100 | 100 | 100 | 99 |
| vinyl compound and conjugated diene | Resin (a) 1-2 | | | | | |
| type hydrocarbon compound; mass % | Resin (a) 1-3 | | | | | |
| | Resin (a) 1-5 | | | | | |
| | Resin (a) 1-6 | | | | | |
| | Resin (a) 1-7 | | | | | |
| | Resin (a) 1-8 | | | | | |
| | Resin (a) 1-9 | | | | | |
| | Resin (a) 1-10 | | | | | |
| Polyolefin resin (b); mass % | Resin (b) 1-1 | | | | | 1 |
| | Resin (b) 1-2 | | | | | |
| | Resin (b) 1-3 | | | | | |
| | Resin (b) 1-4 | | | | | |
| | Resin (b) 1-5 | | | | | |
| | Resin (b) 1-6 | | | | | |
| Antistatic agent; mg/m² | Antistatic | 8 | 8 | 8 | 8 | 8 |
| | agent 1-1 | | | | | |
| | Antistatic | | | | | |
| | agent 1-2 | | | | | |
| Substrate thickness; μm | | 16 | 25 | 16 | 25 | 16 |
| Thickness of polyolefin resin interlayer; μm | | 20 | — | — | — | 20 |
| Thickness of interlayer made of hydrogenated resin of | | — | — | — | — | — |
| styrene/butadiene/styrene triblock copolymer; μm | | | | | | |
| Sealant thickness; μm | | 10 | 30 | 40 | 45 | 20 |
| Total thickness of cover film; μm | | 46 | 55 | 56 | 70 | 56 |
| (1-1) Film forming properties | | Good | Good | Good | Good | Good |
| (2-1) Sealing properties | | Excellent | Excellent | Excellent | Good | Excellent |
| (3-1) Difference between maximum and minimum peel | | Excellent | Excellent | Excellent | Excellent | Excellent |
| strengths | | | | | | |
| (4-1) Adhesion at non-sealing portion | | Good | Good | Good | Good | Good |
| (5) Surface resistance; Ω | | 7.2 × 10¹⁰ | 6.5 × 10¹⁰ | 9.9 × 10¹⁰ | 5.1 × 10¹⁰ | 8.7 × 10¹⁰ |
| | | Ex. 1-16 | Ex. 1-17 | Ex. 1-18 | Ex. 1-19 | Ex. 1-20 |
| Hydrogenated resin (a) of aromatic | Resin (a) 1-1 | 95 | 70 | | | |
| vinyl compound and conjugated diene | Resin (a) 1-2 | | | | | |
| type hydrocarbon compound; mass % | Resin (a) 1-3 | | | | | |
| | Resin (a) 1-5 | | | 85 | 67 | 90 |
| | Resin (a) 1-6 | | | | | |
| | Resin (a) 1-7 | | | | | |
| | Resin (a) 1-8 | | | | | |
| | Resin (a) 1-9 | | | | | |
| | Resin (a) 1-10 | | | | | |
| Polyolefin resin (b); mass % | Resin (b) 1-1 | 5 | 30 | | | |
| | Resin (b) 1-2 | | | 15 | | |
| | Resin (b) 1-3 | | | | 33 | |
| | Resin (b) 1-4 | | | | | 10 |
| | Resin (b) 1-5 | | | | | |
| | Resin (b) 1-6 | | | | | |
| Antistatic agent; mg/m² | Antistatic | 8 | 8 | 8 | 8 | 8 |
| | agent 1-1 | | | | | |
| | Antistatic | | | | | |
| | agent 1-2 | | | | | |

| | | | | | |
|---|---|---|---|---|---|
| Substrate thickness; μm | 16 | 16 | 25 | 25 | 25 |
| Thickness of polyolefin resin interlayer; μm | 20 | 20 | — | — | — |
| Thickness of interlayer made of hydrogenated resin of | — | — | — | — | — |
| styrene/butadiene/styrene triblock copolymer; μm | | | | | |
| Sealant thickness; μm | 20 | 20 | 25 | 25 | 25 |
| Total thickness of cover film; μm | 56 | 56 | 50 | 50 | 50 |
| (1-1) Film forming properties | Good | Good | Good | Good | Good |
| (2-1) Sealing properties | Excellent | Excellent | Excellent | Excellent | Excellent |
| (3-1) Difference between maximum and minimum peel | Excellent | Excellent | Excellent | Good | Excellent |
| strengths | | | | | |
| (4-1) Adhesion at non-sealing portion | Excellent | Excellent | Excellent | Excellent | Excellent |
| (5) Surface resistance; Ω | 4.9 × 10¹⁰ | 8.3 × 10¹⁰ | 6.1 × 10¹⁰ | 7.6 × 10¹⁰ | 5.3 × 10¹⁰ |

TABLE 1-3

| | | Ex. 1-21 | Ex. 1-22 | Ex. 1-23 | Ex. 1-24 | Ex. 1-25 |
|---|---|---|---|---|---|---|
| Hydrogenated resin (a) of aromatic | Resin (a) 1-1 | | | | 100 | 80 |
| vinyl compound and conjugated diene | Resin (a) 1-2 | | | | | |
| type hydrocarbon compound; mass % | Resin (a) 1-3 | | | | | |
| | Resin (a) 1-5 | 75 | 70 | 100 | | |
| | Resin (a) 1-6 | | | | | |
| | Resin (a) 1-7 | | | | | |
| | Resin (a) 1-8 | | | | | |
| | Resin (a) 1-9 | | | | | |
| | Resin (a) 1-10 | | | | | |
| Polyolefin resin (b); mass % | Resin (b) 1-1 | | | | | 20 |
| | Resin (b) 1-2 | | | | | |
| | Resin (b) 1-3 | | | | | |
| | Resin (b) 1-4 | | | | | |
| | Resin (b) 1-5 | 25 | | | | |
| | Resin (b) 1-6 | | 30 | | | |
| Antistatic agent; mg/m² | Antistatic | 8 | 8 | 5 | 10 | 18 |
| | agent 1-1 | | | | | |
| | Antistatic | | | | | |
| | agent 1-2 | | | | | |

| | | | | | |
|---|---|---|---|---|---|
| Substrate thickness; μm | 25 | 25 | 16 | 16 | 16 |
| Thickness of polyolefin resin interlayer; μm | — | — | 20 | 20 | 20 |
| Thickness of interlayer made of hydrogenated resin of | — | — | — | — | — |
| styrene/butadiene/styrene triblock copolymer; μm | | | | | |
| Sealant thickness; μm | 25 | 25 | 20 | 20 | 20 |
| Total thickness of cover film; μm | 50 | 50 | 56 | 56 | 56 |
| (1-1) Film forming properties | Good | Good | Good | Good | Good |
| (2-1) Sealing properties | Excellent | Excellent | Excellent | Excellent | Excellent |
| (3-1) Difference between maximum and minimum peel | Excellent | Excellent | Excellent | Excellent | Excellent |
| strengths | | | | | |
| (4-1) Adhesion at non-sealing portion | Good | Good | Excellent | Excellent | Excellent |
| (5) Surface resistance; Ω | 6.6 × 10¹⁰ | 9.1 × 10¹⁰ | 8.2 × 10¹⁰ | 5.9 × 10¹⁰ | 1.2 × 10¹⁰ |

| | | Ex. 1-26 | Ex. 1-27 | Ex. 1-28 | Ex. 1-29 |
|---|---|---|---|---|---|
| Hydrogenated resin (a) of aromatic | Resin (a) 1-1 | 80 | 80 | | |
| vinyl compound and conjugated diene | Resin (a) 1-2 | | | 100 | |
| type hydrocarbon compound; mass % | Resin (a) 1-3 | | | | 100 |
| | Resin (a) 1-5 | | | | |
| | Resin (a) 1-6 | | | | |
| | Resin (a) 1-7 | | | | |
| | Resin (a) 1-8 | | | | |
| | Resin (a) 1-9 | | | | |
| | Resin (a) 1-10 | | | | |
| Polyolefin resin (b); mass % | Resin (b) 1-1 | 20 | 20 | | |
| | Resin (b) 1-2 | | | | |
| | Resin (b) 1-3 | | | | |
| | Resin (b) 1-4 | | | | |
| | Resin (b) 1-5 | | | | |
| | Resin (b) 1-6 | | | | |
| Antistatic agent; mg/m² | Antistatic | 24 | | | |
| | agent 1-1 | | | | |
| | Antistatic | | 12 | | |
| | agent 1-2 | | | | |

| | | | | |
|---|---|---|---|---|
| Substrate thickness; μm | 16 | 16 | 16 | 16 |
| Thickness of polyolefin resin interlayer; μm | 20 | 20 | — | — |
| Thickness of interlayer made of hydrogenated resin of | — | — | 20 | 20 |
| styrene/butadiene/styrene triblock copolymer; μm | | | | |
| Sealant thickness; μm | 20 | 20 | 20 | 20 |
| Total thickness of cover film; μm | 56 | 56 | 56 | 56 |
| (1-1) Film forming properties | Good | Good | Good | Good |
| (2-1) Sealing properties | Good | Excellent | Excellent | Excellent |
| (3-1) Difference between maximum and minimum peel | Excellent | Excellent | Excellent | Excellent |
| strengths | | | | |
| (4-1) Adhesion at non-sealing portion | Excellent | Excellent | Excellent | Excellent |
| (5) Surface resistance; Ω | 6.7 × 10⁹ | 4.7 × 10¹⁰ | >1 × 10¹⁴ | >1 × 10¹⁴ |

TABLE 1-4

| | | Comp. Ex. | Comp. Ex. | Comp. Ex. | Comp. Ex. | Comp. Ex. |
|---|---|---|---|---|---|---|
| | | 1-1 | 1-2 | 1-3 | 1-4 | 1-5 |
| Hydrogenated resin (a) of aromatic | Resin (a) 1-1 | | | | | |
| vinyl compound and conjugated diene | Resin (a) 1-11 | 100 | | | | |
| type hydrocarbon compound; mass % | Resin (a) 1-12 | | 100 | | | |
| | Resin (a) 1-13 | | | 100 | | |
| | Resin (a) 1-14 | | | | 100 | |
| | Resin (a) 1-15 | | | | | 100 |
| Polyolefin resin (b); mass % | Resin (b) 1-1 | | | | | |
| | Resin (b) 1-2 | | | | | |
| | Resin (b) 1-5 | | | | | |
| | Resin (b) 1-6 | | | | | |
| Antistatic agent; mg/m² | Antistatic | 8 | 8 | 8 | 8 | 8 |
| | agent 1-1 | | | | | |
| | Antistatic | | | | | |
| | agent 1-2 | | | | | |

| | | | | | |
|---|---|---|---|---|---|
| Substrate thickness; μm | 16 | 16 | 16 | 16 | 16 |
| Thickness of polyolefin resin interlayer; μm | 20 | 20 | 20 | 20 | 20 |
| Thickness of interlayer made of hydrogenated resin of | — | — | — | — | — |
| styrene/butadiene/styrene triblock copolymer; μm | | | | | |
| Sealant thickness; μm | 20 | 20 | 20 | 20 | 20 |
| Total thickness of cover film; μm | 56 | 56 | 56 | 56 | 56 |
| (1-1) Film forming properties | Good | Good | Good | Good | Poor |
| (2-1) Sealing properties | Good | Excellent | Excellent | Excellent | Not |
| | | | | | evaluated |
| (3-1) Difference between maximum and minimum peel | Poor | Good | Poor | Poor | Not |
| strengths | | | | | evaluated |
| (4-1) Adhesion at non-sealing portion | Excellent | Poor | Poor | Poor | Not |
| | | | | | evaluated |
| (5) Surface resistance; Ω | 8.5 × 10¹⁰ | 6.1 × 10¹⁰ | 7.7 × 10¹⁰ | 5.1 × 10¹⁰ | >1 × 10¹⁴ |

| | | Comp. Ex. | Comp. Ex. | Comp. Ex. | Comp. Ex. |
|---|---|---|---|---|---|
| | | 1-6 | 1-7 | 1-8 | 1-9 |
| Hydrogenated resin (a) of aromatic | Resin (a) 1-1 | 62 | 60 | 62 | 60 |
| vinyl compound and conjugated diene | Resin (a) 1-11 | | | | |
| type hydrocarbon compound; mass % | Resin (a) 1-12 | | | | |
| | Resin (a) 1-13 | | | | |
| | Resin (a) 1-14 | | | | |
| | Resin (a) 1-15 | | | | |
| Polyolefin resin (b); mass % | Resin (b) 1-1 | 38 | | | |
| | Resin (b) 1-2 | | 40 | | |
| | Resin (b) 1-5 | | | 38 | |
| | Resin (b) 1-6 | | | | 40 |
| Antistatic agent; mg/m² | Antistatic | 8 | 8 | 8 | 8 |
| | agent 1-1 | | | | |
| | Antistatic | | | | |
| | agent 1-2 | | | | |

| | | | | |
|---|---|---|---|---|
| Substrate thickness; μm | 25 | 25 | 25 | 25 |
| Thickness of polyolefin resin interlayer; μm | — | — | — | — |
| Thickness of interlayer made of hydrogenated resin of | — | — | — | — |
| styrene/butadiene/styrene triblock copolymer; μm | | | | |
| Sealant thickness; μm | 25 | 25 | 25 | 25 |
| Total thickness of cover film; μm | 50 | 50 | 50 | 50 |
| (1-1) Film forming properties | Good | Good | Good | Good |
| (2-1) Sealing properties | Good | Good | Good | Good |
| (3-1) Difference between maximum and minimum peel | Poor | Poor | Poor | Poor |
| strengths | | | | |
| (4-1) Adhesion at non-sealing portion | Excellent | Excellent | Poor | Good |
| (5) Surface resistance; Ω | 8.3 × 10¹⁰ | 5.9 × 10¹⁰ | 7.0 × 10¹⁰ | 9.4 × 10¹⁰ |

TABLE 2-1

| | | Ex. 2-1 | Ex. 2-2 | Ex. 2-3 | Ex. 2-4 | Ex. 2-5 |
|---|---|---|---|---|---|---|
| Hydrogenated resin (a) of aromatic | Resin (a) 1-1 | 90 | 85 | 76 | | |
| vinyl compound and conjugated diene | Resin (a) 1-6 | | | | 85 | |
| type hydrocarbon compound; mass % | Resin (a) 2-1 | | | | | 85 |
| Polyolefin resin (b); mass % | Resin (b) 2-1 | 10 | 15 | 24 | 15 | 15 |
| | Resin (b) 2-2 | | | | | |
| | Resin (b) 2-3 | | | | | |
| | Resin (b) 2-4 | | | | | |
| | Resin (b) 2-5 | | | | | |
| | Resin (b) 2-6 | | | | | |
| Antistatic agent | Antistatic | 7 | 7 | 7 | 7 | 7 |
| | agent 2-1 | | | | | |
| Substrate thickness; μm | | 16 | 16 | 16 | 16 | 16 |
| Thickness of interlayer; μm | | 13 | 13 | 13 | 13 | 13 |
| Sealant thickness; μm | | 30 | 30 | 30 | 30 | 30 |
| Total thickness of cover film; μm | | 59 | 59 | 59 | 59 | 59 |
| (1-2) Extrudability | | Excellent | Excellent | Excellent | Excellent | Good |
| (2-2) Sealing properties | | Excellent | Excellent | Excellent | Excellent | Good |
| (3-2) Difference between maximum and minimum peel | | Excellent | Excellent | Excellent | Excellent | Good |
| strengths | | | | | | |
| (4-2) Adhesion at non-sealing portion | | Excellent | Excellent | Excellent | Good | Excellent |
| (5) Surface resistance; Ω | | 8.3 × 10⁹ | 7.8 × 10⁹ | 7.5 × 10⁹ | 7.4 × 10⁹ | 5.8 × 10⁹ |
| (6) Stability of peel strength with time | | Good | Excellent | Excellent | Good | Good |
| | | Ex. 2-6 | Ex. 2-7 | Ex. 2-8 | Ex. 2-9 | Ex. 2-10 |
| Hydrogenated resin (a) of aromatic | Resin (a) 1-1 | 85 | 85 | 85 | 85 | 85 |
| vinyl compound and conjugated diene | Resin (a) 1-6 | | | | | |
| type hydrocarbon compound; mass % | Resin (a) 2-1 | | | | | |
| Polyolefin resin (b); mass % | Resin (b) 2-1 | | | | | |
| | Resin (b) 2-2 | 15 | | | | |
| | Resin (b) 2-3 | | 15 | | | |
| | Resin (b) 2-4 | | | 15 | | |
| | Resin (b) 2-5 | | | | 15 | |
| | Resin (b) 2-6 | | | | | 15 |
| Antistatic agent | Antistatic | 7 | 7 | 7 | 7 | 7 |
| | agent 2-1 | | | | | |

| | | | | | |
|---|---|---|---|---|---|
| Substrate thickness; μm | 16 | 16 | 16 | 16 | 16 |
| Thickness of interlayer; μm | 13 | 13 | 13 | 13 | 13 |
| Sealant thickness; μm | 30 | 30 | 30 | 30 | 30 |
| Total thickness of cover film; μm | 59 | 59 | 59 | 59 | 59 |
| (1-2) Extrudability | Excellent | Excellent | Excellent | Excellent | Excellent |
| (2-2) Sealing properties | Excellent | Excellent | Excellent | Excellent | Excellent |
| (3-2) Difference between maximum and minimum peel | Excellent | Excellent | Excellent | Excellent | Excellent |
| strengths | | | | | |
| (4-2) Adhesion at non-sealing portion | Excellent | Excellent | Excellent | Excellent | Excellent |
| (5) Surface resistance; Ω | 6.4 × 10⁹ | 8.2 × 10⁹ | 8.7 × 10⁹ | 6.4 × 10⁹ | 6.8 × 10⁹ |
| (6) Stability of peel strength with time | Excellent | Excellent | Excellent | Excellent | Excellent |

TABLE 2-2

| | | Ex. 2-11 | Ex. 2-12 | Ex. 2-13 | Ex. 2-14 | Ex. 2-15 |
|---|---|---|---|---|---|---|
| Hydrogenated resin (a) of aromatic | Resin (a) 1-1 | 85 | 85 | 85 | 80 | 85 |
| vinyl compound and conjugated diene | | | | | | |
| type hydrocarbon compound; mass % | | | | | | |
| Polyolefin resin (b); mass % | Resin (b) 2-7 | 15 | | | | |
| | Resin (b) 2-8 | | 15 | | | |
| | Resin (b) 2-9 | | | 15 | 20 | |
| | Resin (b) 2-10 | | | | | 15 |
| | Resin (b) 2-11 | | | | | |
| | Resin (b) 2-12 | | | | | |
| | Resin (b) 2-13 | | | | | |
| | Resin (b) 2-14 | | | | | |
| | Resin (b) 2-15 | | | | | |
| Antistatic agent | Antistatic | 7 | 7 | 7 | 7 | 7 |
| | agent 2-1 | | | | | |
| Substrate thickness; μm | | 16 | 16 | 16 | 16 | 16 |
| Thickness of interlayer; μm | | 13 | 13 | 13 | 13 | 13 |
| Sealant thickness; μm | | 30 | 30 | 30 | 30 | 30 |
| Total thickness of cover film; μm | | 59 | 59 | 59 | 59 | 59 |
| (1-2) Extrudability | | Excellent | Excellent | Excellent | Excellent | Excellent |
| (2-2) Sealing properties | | Good | Good | Excellent | Excellent | Excellent |
| (3-2) Difference between maximum and minimum peel | | Good | Good | Excellent | Excellent | Excellent |
| strengths | | | | | | |
| (4-2) Adhesion at non-sealing portion | | Excellent | Excellent | Excellent | Excellent | Good |
| (5) Surface resistance; Ω | | 8.4 × 10⁹ | 7.0 × 10⁹ | 8.2 × 10⁹ | 9.8 × 10⁹ | 8.6 × 10⁹ |
| (6) Stability of peel strength with time | | Excellent | Excellent | Excellent | Excellent | Excellent |
| | | Ex. 2-16 | Ex. 2-17 | Ex. 2-18 | Ex. 2-19 | Ex. 2-20 |
| Hydrogenated resin (a) of aromatic | Resin (a) 1-1 | 85 | 85 | 85 | 80 | 85 |
| vinyl compound and conjugated diene | | | | | | |
| type hydrocarbon compound; mass % | | | | | | |
| Polyolefin resin (b); mass % | Resin (b) 2-7 | | | | | |
| | Resin (b) 2-8 | | | | | |
| | Resin (b) 2-9 | | | | | |
| | Resin (b) 2-10 | | | | | |
| | Resin (b) 2-11 | 15 | | | | |
| | Resin (b) 2-12 | | 15 | | | |
| | Resin (b) 2-13 | | | 15 | | |
| | Resin (b) 2-14 | | | | 15 | |
| | Resin (b) 2-15 | | | | | 15 |
| Antistatic agent | Antistatic | 7 | 7 | 7 | 7 | 7 |
| | agent 2-1 | | | | | |

| | | | | | |
|---|---|---|---|---|---|
| Substrate thickness; μm | 16 | 16 | 16 | 16 | 16 |
| Thickness of interlayer; μm | 13 | 13 | 13 | 13 | 13 |
| Sealant thickness; μm | 30 | 30 | 30 | 30 | 30 |
| Total thickness of cover film; μm | 59 | 59 | 59 | 59 | 59 |
| (1-2) Extrudability | Excellent | Excellent | Excellent | Excellent | Excellent |
| (2-2) Sealing properties | Excellent | Excellent | Excellent | Excellent | Excellent |
| (3-2) Difference between maximum and minimum peel | Excellent | Excellent | Good | Excellent | Excellent |
| strengths | | | | | |
| (4-2) Adhesion at non-sealing portion | Good | Good | Excellent | Good | Good |
| (5) Surface resistance; Ω | 6.8 × 10⁹ | 9.0 × 10⁹ | 6.7 × 10⁹ | 7.0 × 10⁹ | 6.1 × 10⁹ |
| (6) Stability of peel strength with time | Excellent | Good | Excellent | Excellent | Good |

TABLE 2-3

| | | Ex. 2-21 | Ex. 2-22 | Ex. 2-23 | Ex. 2-24 | Ex. 2-25 |
|---|---|---|---|---|---|---|
| Hydrogenated resin (a) of aromatic | Resin (a) 1-1 | 85 | 85 | 85 | 85 | 80 |
| vinyl compound and conjugated diene | | | | | | |
| type hydrocarbon compound; mass % | | | | | | |
| Polyolefin resin (b); mass % | Resin (b) 2-1 | | | 15 | 15 | 20 |
| | Resin (b) 2-16 | 15 | | | | |
| | Resin (b) 2-17 | | 15 | | | |
| Antistatic agent | Antistatic | 7 | 7 | 7 | 7 | 7 |
| | agent 2-1 | | | | | |

| | | | | | |
|---|---|---|---|---|---|
| Substrate thickness; μm | 16 | 16 | 9 | 75 | 16 |
| Thickness of interlayer; μm | 13 | 13 | 13 | 13 | 13 |
| Sealant thickness; μm | 30 | 30 | 30 | 30 | 45 |
| Total thickness of cover film; μm | 59 | 59 | 52 | 118 | 74 |
| (1-2) Extrudability | Excellent | Excellent | Excellent | Excellent | Excellent |
| (2-2) Sealing properties | Excellent | Excellent | Excellent | Good | Excellent |
| (3-2) Difference between maximum and minimum peel | Excellent | Excellent | Excellent | Excellent | Excellent |
| strengths | | | | | |
| (4-2) Adhesion at non-sealing portion | Good | Good | Excellent | Excellent | Excellent |
| (5) Surface resistance; Ω | 4.5 × 10⁹ | 5.4 × 10⁹ | 5.8 × 10⁹ | 6.9 × 10⁹ | 7.0 × 10⁹ |
| (6) Stability of peel strength with time | Good | Good | Excellent | Excellent | Excellent |

| | | Ex. 2-26 | Ex. 2-27 | Ex. 2-28 |
|---|---|---|---|---|
| Hydrogenated resin (a) of aromatic | Resin (a) 1-1 | 80 | 80 | 80 |
| vinyl compound and conjugated diene | | | | |
| type hydrocarbon compound; mass % | | | | |
| Polyolefin resin (b); mass % | Resin (b) 2-1 | 20 | 20 | 20 |
| | Resin (b) 2-16 | | | |
| | Resin (b) 2-17 | | | |
| Antistatic agent | Antistatic | 7 | 7 | 7 |
| | agent 2-1 | | | |

| | | | |
|---|---|---|---|
| Substrate thickness; μm | 16 | 16 | 16 |
| Thickness of interlayer; μm | 13 | 36 | 36 |
| Sealant thickness; μm | 55 | 12 | 6 |
| Total thickness of cover film; μm | 84 | 64 | 58 |
| (1-2) Extrudability | Excellent | Good | Good |
| (2-2) Sealing properties | Good | Excellent | Good |
| (3-2) Difference between maximum and minimum peel | Excellent | Excellent | Excellent |
| strengths | | | |
| (4-2) Adhesion at non-sealing portion | Excellent | Excellent | Excellent |
| (5) Surface resistance; Ω | 8.9 × 10⁹ | 6.5 × 10⁹ | 8.8 × 10⁹ |
| (6) Stability of peel strength with time | Excellent | Excellent | Excellent |

TABLE 2-4

| | | Comp. Ex. | Comp. Ex. | Comp. Ex. | Comp. Ex. | Comp. Ex. |
|---|---|---|---|---|---|---|
| | | 2-1 | 2-2 | 2-3 | 2-4 | 2-5 |
| Hydrogenated resin (a) of aromatic | Resin (a) 1-1 | | | | 60 | |
| vinyl compound and conjugated diene | Resin (a) 2-1 | | | | | 75 |
| type hydrocarbon compound; mass % | Resin (a) 2-2 | 85 | | | | |
| | Resin (a) 1-11 | | 85 | | | |
| | Resin (a) 2-3 | | | 85 | | |
| Polyolefin resin (b); mass % | Resin (b) 2-1 | 15 | 15 | 15 | 40 | 25 |
| | Resin (b) 2-2 | | | | | |
| | Resin (b) 2-3 | | | | | |
| Antistatic agent | Antistatic | 7 | 7 | 7 | 7 | 7 |
| | agent 2-1 | | | | | |

| | | | | | |
|---|---|---|---|---|---|
| Substrate thickness; μm | 25 | 25 | 25 | 25 | 25 |
| Thickness of interlayer; μm | 13 | 13 | 13 | 13 | 13 |
| Sealant thickness; μm | 30 | 30 | 30 | 30 | 30 |
| Total thickness of cover film; μm | 68 | 68 | 68 | 68 | 68 |
| (1-2) Extrudability | Excellent | Good | Excellent | Excellent | Good |
| (2-2) Sealing properties | Excellent | Poor | Poor | Poor | Poor |
| (3-2) Difference between maximum and minimum peel | Excellent | Good | Good | Poor | Poor |
| strengths | | | | | |
| (4-2) Adhesion at non-sealing portion | Poor | Excellent | Excellent | Excellent | Excellent |
| (5) Surface resistance; Ω | 8.3 × 10⁹ | 8.1 × 10⁹ | 5.9 × 10⁹ | 6.8 × 10⁹ | 7.0 × 10⁹ |
| (6) Stability of peel strength with time | Poor | Good | Good | Excellent | Good |

### INDUSTRIAL APPLICABILITY

The cover film of the present invention is excellent in stability of peel strength at the time of peeling and heat sealing properties, and with the cover film of the present invention, the temperature range of a sealing iron is wide at the time of heat sealing, the time over which the sealing iron is pressed is short, and high speed sealing is possible. Thus, the cover film of the present invention can be preferably used for automatic mounting of electronic equipment, etc.

The entire disclosures of Japanese Patent Application No. 2006-120490 filed on Apr. 25, 2006 and Japanese Patent Application No. 2006-354441 filed on Dec. 28, 2006 including specifications, claims and summaries are incorporated herein by reference in their entireties.

1. A cover film comprising a substrate layer and a sealant layer, wherein the substrate layer is made of a biaxially oriented polyester and/or a biaxially oriented polypropylene, the sealant layer contains a hydrogenated resin (a) of a block copolymer of an aromatic vinyl compound and a conjugated diene type hydrocarbon compound, the amount of the aromatic vinyl compound in the resin (a) is at least 20 mass % and at most 45 mass %, and the flowability of the resin (a) is from 1 to 20 g/10 min at a temperature of 230° C. under a load of 2.16 kgf by a measurement method stipulated in JIS K 7210.

2. A cover film comprising a substrate layer and a sealant layer, wherein the substrate layer is made of a biaxially oriented polyester and/or a biaxially oriented polypropylene, the sealant layer contains a hydrogenated resin (a) of a block copolymer of an aromatic vinyl compound and a conjugated diene type compound and a polyolefin resin (b) in a content of the resin (a) of at least 65 mass % and at most 99 mass % and a content of the polyolefin resin (b) of at least 1 mass % and at most 35 mass %, the amount of the aromatic vinyl compound in the resin (a) is at least 20 mass % and at most 45 mass %, and the flowability of the resin (a) is from 1 to 20 g/10 min at a temperature of 230° C. under a load of 2.16 kgf by a measurement method stipulated in JIS K 7210.

3. A cover film comprising a substrate layer and a sealant layer, wherein the substrate layer is made of a biaxially oriented polyester and/or a biaxially oriented polypropylene, the sealant layer contains a hydrogenated resin (a) of a block copolymer of an aromatic vinyl compound and a conjugated diene type hydrocarbon compound and a polyolefin resin (b) in a content of the resin (a) of at least 75 mass % and at most 90 mass % and a content of the polyolefin resin (b) of at least 10 mass % and at most 25 mass %, and the amount of the aromatic vinyl compound in the resin (a) is at least 20 mass % and at most 45 mass %.

4. The cover film according to claim 2, wherein the polyolefin rein (b) is at least one member selected from the group consisting of a polyethylene resin, an ethylene/acrylic ester copolymer resin and an ethylene/vinyl acetate copolymer resin, and the flowability of the resin (b) is from 0.1 to 10 g/10 min at a temperature of 230° C. under a load of 2.16 kg by a measurement method stipulated in JIS K 7210.

5. The cover film according to claim 2, wherein of the polyolefin resin (b), the elastic modulus at 25° C. is at least 2.0×10⁷ Pa and at most 1.0×10⁹ Pa as measured in a viscoelastic spectrum (elastic modulus in tension, frequency 1 Hz, heating rate of 5° C. per minute), and the melting point (peak temperature) is at least 60° C. and at most 115° C. as measured by a DSC method at a heating rate of 5° C. per minute.

6. The cover film according to claim 1, which contains a surfactant type antistatic agent on one side or both sides of the sealant layer, and wherein the surface resistance is at most 1×10¹²Ω as measured by a measurement method stipulated in JIS K 6911 at an ambient temperature of 23° C. at an ambient humidity of 50% RH at an applied voltage of 500 V.

7. The cover film according to claim 6, wherein the amount of solid content of the applied sealant type antistatic agent is at least 3 mg/m² and at most 20 mg/m².

8. The cover film according to claim 1, wherein the thickness of the sealant layer is at least 8 μm and at most 40 μm.

9. An electronic component packaging container using the cover film as defined in claim 1.
